(19) United States
(12) Patent Application Publication
(10) Pub. No.: US 2024/0236896 A9
(43) Pub. Date: Jul. 11, 2024

(54) Wireless Device, Network Node, and Methods in a Wireless Communications Network

(71) Applicant: Telefonaktiebolaget LM Ericsson (publ), Stockholm (SE)

(72) Inventors: Jan Christoffersson, Luleå (SE); Santhan Thangarasa, Vällingby (SE); Muhammad Kazmi, Sundbyberg (SE)

(21) Appl. No.: 18/279,523

(22) PCT Filed: Feb. 18, 2022
(86) PCT No.: PCT/SE2022/050176

§ 371 Date: Aug. 30, 2023

Related U.S. Application Data
(60) Provisional application No. 63/162,592, filed on Mar. 18, 2021.

(51) Int. Cl. H04W 56/00

(52) U.S. Cl. CPC H04W 56/0045

(57) ABSTRACT

A method performed by a wireless device for handling configured resources for a data transmission to a network node in a wireless communications network is provided. When being in connected mobility state, the wireless device receives (201) a configuration from the network node at a first point in time, T1. The configuration is for resources for the data transmission. The wireless device enters (202) into inactive mobility state. When being in inactive mobility state, the wireless device deciding (203) whether or not a Timing Advance, TA, for the resources configured at T1 for the data transmission is valid at a second point in time, T2. The wireless device sends (204) an indication to the network node, indicating whether or not the TA for the resources configured for the data transmission at T1 is valid at a second point in time, T2, as decided.

### TECHNICAL FIELD

Embodiments herein relate to a wireless device, a network node, and methods therein. In some aspects, they relate to handling configured resources for a data transmission, e.g., to a network node in a wireless communications network.

### BACKGROUND

In a typical wireless communication network, wireless devices, also known as wireless communication devices, mobile stations, stations (STA) and/or User Equipments (UE), communicate via a Wide Area Network or a Local Area Network such as a WI-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a WI-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 gigahertz (GHz) frequency bands. Some of these bands are bands traditionally used by legacy standards but have been extended to cover potential new spectrum offerings from 410 megahertz (MHz) to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

Small Data Transmission

NR supports Radio Resource Control (RRC) with an inactive state, which is also referred to as RRC_INACTIVE. UEs with infrequent, periodic and/or non-periodic, data transmissions, are generally maintained by the network in the RRC_INACTIVE state. Until Release 16, the RRC_INACTIVE state does not support data transmission. Hence, the UE has to resume the connection, i.e. move to an RRC connected state, also referred to as RRC_CONNECTED state, for any Downlink (DL) and Uplink (UL) data. Connection setup and subsequently release to INACTIVE state happens for each data transmission. This results in unnecessary power consumption and signaling overhead. For this reason, support for transmission using Preconfigured Uplink Resources (PUR) is being introduced. The UE is allocated with PUR resources during RRC connected state and is also assigned a pre-configured Timing Advance (TA) value by the network node in the serving cell. It is expected that the PUR resources may be of different types, namely dedicated, contention-free shared or contention-based shared PUR resource. A PUR resource is defined as a physical channel resource such as a physical channel, e.g. a Physical Uplink Shared Channel (PUSCH) resource such as resource blocks for PUSCH. This is a resource allocated in both time and frequency domain. The UE uses the preconfigured TA value when transmitting using the PUR resources in idle state, provided that the serving cell of the UE is not changed. If the serving cell changes then the PUR resources and TA value from the old serving cell become invalid.

NR Solutions for Supporting Small Data Transmission

In NR Release 17, Small Data Transmission (SDT) work item, two main solutions will be specified for enabling SDT in RRC_INACTIVE state: Random-Access Channel (RACH) based SDT, i.e., transmitting small data on Message A PUSCH in a 2-step RACH procedure, or transmitting small data on Message 3 PUSCH in a 4-step RACH procedure, and Configured Grant (CG) based SDT, i.e., SDT over configured grant type-1 PUSCH resources for UEs in RRC inactive state.

The 2-step and/or 4-step RACH and configured grant type have already been specified as part of Release 15 and Release 16. So, the SDT features to be specified in NR

Release 17 build on these building blocks to enable small data transmission in INACTIVE state for NR.

In 3GPP draft R2-2102090, “LS on uplink timing alignment for small data transmissions”, the following agreements were made in RAN2 for CG based SDT scheme:
1. CG-SDT resource configuration is provided to UEs in RRC_Connected only within the RRCRelease message, i.e. no need to also include it in RRCReconfiguration message
2. CG-PUSCH resources can be separately configured for Normal UL (NUL) and Supplementary UL (SUL). For further study if we allow them at the same time. This depends on the alignments Change Request (CRs) for Release 16.
3. For CG-SDT the subsequent data transmission can use the CG resource or Dynamic Grant (DG), i.e., dynamic grant addressed to UE's Cell Radio Network Temporary Identifier (C-RNTI). Details on C-RNTI, can be the same as the previous C-RNTI or may be configured explicitly by the network can be discussed in stage 3
4. Time Alignment Timer (TAT)-SDT is started upon receiving the TAT-SDT configuration from gNB, i.e. RRCrelease message, and can be started or restarted upon reception of TA command.
5. From RAN2 point of view, assume similar to PU R, that we introduce a TA validation mechanism for SDT based on Reference Signal Receive Power (RSRP) change, i.e. RSRP-based threshold(s) are configured. For further study on how to handle CG configuration when TA expires or when TA is invalid due to RSRP threshold. Details of the TA validation procedure can be further discussed.
6. UE releases CG-SDT resources when TAT expires in RRC_Inactive state.

NR CG Based PUSCH Transmission

CG PUSCH resources are the PUSCH resources configured in advance for the UE. When there is uplink data available at UE's buffer, it can immediately start uplink transmission using the pre-configured PUSCH resources without waiting for an UL grant from the gNB, thus reducing the latency. NR supports CG type 1 PUSCH transmission and CG type 2 PUSCH transmission. For both two types, the PUSCH resources, e.g. time and frequency allocation, periodicity, etc., are preconfigured via dedicated RRC signaling. The CG type 1 PUSCH transmission is activated/deactivated by RRC signaling, while the CG type 2 PUSCH transmission is activated/deactivated by an UL grant using Downlink Control Information (DCI) signaling.

NR SSB Transmission

Beamforming is important for improving the coverage of Synchronization Signals (SSs) and Physical Broadcast Channel (PBCH) block (referred to as SSB in 3GPP) transmission, especially for compensating the high path loss in high carrier frequency bands. To support beamforming and beam-sweeping for SSB transmission, in NR, a cell can transmit multiple SSBs in different narrow-beams in a time multiplexed fashion. The transmission of these SS/PBCH blocks is confined to a half frame time interval, e.g. 5 ms. Each SSB is also interchangeably called as a beam e.g. DL beam, DL reference signal beam etc.

The maximum number of SSBs within a half frame, i.e., 5 ms, denoted by L, depends on the frequency band, and it is defined as follows:
Licensed Frequency Division Duplex (FDD) bands
   For carrier frequencies smaller than or equal to 3 GHz, L=4;
   For carrier frequencies larger than 3 GHz, L=8;
Licensed Time-division duplexing (TDD) bands
   For carrier frequencies smaller than or equal to 1.88 GHz, L=4;
   For carrier frequencies within FR1 larger than 1.88 GHz, L=8;
   For carrier frequencies within FR2, L=64.

SSB(s) to CG Association

One or multiple SSBs can be associated with each CG configuration for CG-SDT. For detail mapping or association between SSBs and CG configuration, at least two solutions are considered: one alternative is to reuse the SSB-to-RO mapping rule as much as possible, where RO herein means RACH Occasion (RO).

The other alternative is to associate the CG resources per CG configuration with a set of SSB(s) that is explicitly configured for the CG configuration. Other solutions for mapping between SSB(s) and CG can also be considered.

A CG configuration comprises a set of CG resources e.g. transmission occasions, Demodulation Reference Signal (DMRS), PUSCH resources, PUSCH repetitions etc.

PUSCH Repetition in NR Release 15 and Release 16 NR Release 15

Slot aggregation for PUSCH is supported in Release 15 and renamed to PUSCH Repetition Type A in Release 16. The name PUSCH repetition Type A is used even if there is only a single repetition, i.e. no slot aggregation. In Release 15, a PUSCH transmission that overlaps with DL symbols is not transmitted.

For DCI granted multi-slot transmission Physical Downlink Shared Channel (PDSCH) and/or PUSCH, vs semi-static DL/UL assignment:
If semi-static DL/UL assignment configuration of a slot has no direction confliction with scheduled PDSCH/PUSCH assigned symbols, the PDSCH/PUSCH in that slot is received/transmitted
If semi-static DL/UL assignment configuration of a slot has direction confliction with scheduled PDSCH/PUSCH assigned symbols, the PDSCH/PUSCH transmission in that slot is not received/transmitted, i.e. the effective number of repetitions reduces

In Release 15, the number of repetitions is semi-statically configured by RRC parameter pusch-AggregationFactor. At most 8 repetitions are supported. E.g. pusch-Aggregation Factor ENUMERATED {n2, n4, n8}.

NR Release 16

A new repetition format PUSCH repetition Type B is supported in Release 16, which allows back-to-back repetition of PUSCH transmissions. The main difference between the two types of repetition is that repetition Type A only allows a single repetition in each slot, with each repetition occupying the same symbols within the slot. Using this type A repletion, when a PUSCH repletion has a number of symbols shorter than 14 symbols, it introduces gaps between repetitions, increasing the overall latency.

Another change compared to Release 15 is how the number of repetitions is signaled. In Release 15, the number of repetitions is semi-statically configured, while in Release 16 the number of repetitions can be indicated dynamically in DCI. This applies both to dynamic grants and configured grants type 2.

In NR Release 16, invalid symbols for PUSCH repetition Type B include reserved UL resources. The invalid symbol pattern indicator field is configured in the scheduling DCI. Segmentation occurs around symbols that are indicated as DL by the semi-static TDD pattern and invalid symbols.

Time Alignment in NR

In RRC_CONNECTED, the gNB is responsible for maintaining the timing advance to keep the L1 synchronized. Serving cells having UL to which the same timing advance applies and using the same timing reference cell are grouped in a TA Group (TAG). Each TAG contains at least one serving cell with configured uplink, and the mapping of each serving cell to a TAG is configured by RRC.

For the primary TAG the UE uses the Primary Cell (PCell) as timing reference, except with shared spectrum channel access where a Secondary Cell (SCell) can also be used in certain cases. In a secondary TAG, the UE may use any of the activated SCells of this TAG as a timing reference cell, but should not change it unless necessary. Timing advance updates are signaled by the gNB to the UE via Medium Access

Control (MAC) Coverage Enhancement CE commands. Such commands restart a TAG-specific timer which indicates whether the L1 can be synchronized or not: when the timer is running, the L1 is considered synchronized, otherwise, the L1 is considered non-synchronized, e.g. in which case uplink transmission can only take place on PRACH. The TA timer is configured in TAG-Config 1E in the Information Element (IE) MAC-CellGroupCon fig which is used to configure MAC parameters for a cell group, including Discontinuous Reception (DRX).

-- ASN1START
-- TAG-TAG-CONFIG-START

| | |
|---|---|
| TAG-Config ::= | SEQUENCE { |
| tag-ToReleaseList | SEQUENCE (SIZE (1..maxNrofTAGs)) |
| | OF TAG-Id |

OPTIONAL, -- Need N

| | |
|---|---|
| tag-ToAddModList | SEQUENCE (SIZE (1..maxNrofTAGs)) |
| | OF TAG |

OPTIONAL -- Need N
}

| | |
|---|---|
| TAG ::= | SEQUENCE { |
| tag-Id | TAG-Id, |
| timeAlignmentTimer | TimeAlignmentTimer, |

...
}

| | |
|---|---|
| TimeAlignmentTimer ::= | ENUMERATED {ms500, ms750, ms1280, |

ms1920, ms2560, ms5120, ms10240, infinity}
-- TAG-TAG-CONFIG-STOP
-- ASN1STOP|

TAG field descriptions
tag-Id
Indicates the TAG of the Special Cell (SpCell) or an SCell. Uniquely
identifies the TAG within the scope of a Cell Group, i.e. Master Cell
Group (MCG) or Secondary Cell Group (SCG).
timeAlignmentTimer
Value in ms of the timeAlignmentTimer for TAG with ID tag-Id.

### SUMMARY

As a part of developing embodiments herein the inventors identified a problem which first will be discussed.

In the SDT, the UE may also be configured to check the validity of the TA value based on one or more other criteria which are e.g. related to changes in the RRM measurements, e.g. signal strength measurements.

Transmission in INACTIVE mode, also referred to as INACTIVE state, using preconfigured uplink resources is realized by a UE obtaining a Timing Advance (TA) command in the Radio Resource Control (RRC)_CONNECTED state and later using that TA in INACTIVE state for adjusting the UE timing for the uplink transmission. However, the uplink transmission using PUR in INACTIVE state may not take place immediately or within short time after the reception of the PUR configuration including TA command. Typically, it occurs later in time. Prior to transmission, the UE is required to validate the received TA which is done using different TA validation methods such as changes in RRM measurements, association between DL and UL beams etc. The UE is allowed to transmit using the configured uplink PUSCH CG resources only if TA is evaluated to be valid. Otherwise it is not allowed to transmit using the configured uplink CG resources for PUSCH.

The problem with this way of operating is that only the UE knows the outcome of the TA evaluation, and the network node which has preconfigured the CG resources has no information whether the TA is valid at the UE. Due to invalid TA, the UE is not allowed to transmit using the configured resources even if data is available in the buffer, thus the UE may e.g. drop, delay or suspend the intended SDT transmission. Consequently, the CG resources which were configured or reserved by the network node then remains reserved and is not usable by other UEs. The configured or reserved CG resources thus become wasted, for some time until the network node releases those resources. Compared to FR1, a lot more CG resources are configured in FR2 due to PUSCH configurations in multiple beams. Thus, the problem of CG resources becoming not usable or wasted due to invalid TA, is more severe in FR2.

Hence, a new mechanism is needed to more efficiently maintain configured CG resources in the network node.

An object of embodiments herein is to improve the performance of a wireless communications network using preconfigured uplink resources for SDT.

According to an aspect of embodiments herein, the object is achieved by a method performed by a wireless device for handling configured resources for a data transmission to a network node in a wireless communications network. When being in connected mobility state, the wireless device receives a configuration from the network node at a first point in time, T1. The configuration is for resources for the data transmission. The wireless device enters into inactive mobility state. When being in inactive mobility state, the wireless device deciding whether or not a Timing Advance, TA, for the resources configured at T1 for the data transmission is valid at a second point in time, T2. The wireless device sends an indication to the network node, indicating whether or not the TA for the resources configured for the data transmission at T1 is valid at a second point in time, T2, as decided.

According to an aspect of embodiments herein, the object is achieved by a method performed by a network node for handling resources for a data transmission. The network node configures a wireless device at a first point in time, T1. The wireless device is configured with resources for the data transmission. The data transmission is from the wireless device to the network node in a wireless communications network. When the wireless device is in an inactive mobility state, the network node receives an indication from the wireless device. The indication indicates whether or not the TA for the resources configured at T1 for the data transmission is valid at a second point in time, T2, as decided by the wireless device.

According to an aspect of embodiments herein, the object is achieved by a wireless device configured to handle configured resources for a data transmission to a network node in a wireless communications network. The wireless device is further configured to:
When being in connected mobility state, receive from the network node at a first point in time, T1, a configuration for resources, for the data transmission, enter into inactive mobility state,
when being in inactive mobility state, decide whether or not a Timing Advance, TA, for the resources configured at T1 for the data transmission is valid at a second point in time, T2,
send an indication to the network node, indicating whether or not the TA for the resources configured at T1 for the data transmission is valid at a second point in time, T2, as decided.

According to an aspect of embodiments herein, the object is achieved by a network node configured to handle resources for a data transmission. The network node is further configured to:
Configure at a first point in time, T1, a wireless device with resources, for the data transmission, which data transmission is arranged to be from the wireless device to the network node in a wireless communications network,
when the wireless device is in an inactive mobility state, receive an indication from the wireless device, which indication is adapted to indicate whether or not the TA for the resources configured at T1 for the data transmission is valid at a second point in time, T2, as arranged to be decided by the wireless device.

An advantage with embodiments is that the configured resources are released earlier when the wireless device 120 is not expected to use them.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting an embodiment of a method in a wireless device.

FIG. 3 is a flowchart depicting an embodiment of a method in a network node.

FIG. 4 is a schematic block diagram depicting an embodiment herein.

FIG. 5 is a schematic block diagram depicting an embodiment herein.

FIG. 6 is a schematic block diagram depicting an embodiment herein.

FIG. 7 is a schematic block diagram depicting an embodiment herein.

FIG. 8 is a schematic block diagram depicting an embodiment herein.

FIGS. 9a and b are schematic block diagrams illustrating embodiments of a wireless device.

FIGS. 11a and b are schematic block diagrams illustrating embodiments of a network node.

FIG. 11 schematically illustrates a telecommunication network connected via an intermediate network to a host computer.

FIG. 12 is a generalized block diagram of a host computer communicating via a base station with a user equipment over a partially wireless connection.

FIGS. 13-16 are flowcharts illustrating methods implemented in a communication system including a host computer, a base station and a user equipment.

### DETAILED DESCRIPTION

Some embodiments herein, prove a method wherein a wireless device such as a UE determines, e.g. decides whether a TA that is valid at a first point in time also is valid for the configured resources, later, at a second point in time, such as CG, based transmission, e.g. SDT, then the UE also reports, e.g. sends an indication, to the network (e.g. a serving cell) indicating whether or not the TA is valid. The UE may further be configured to report that the TA is invalid when one or more conditions is met e.g. based on amount of CG resources, if there is sufficient remaining time for TAT to expire etc.

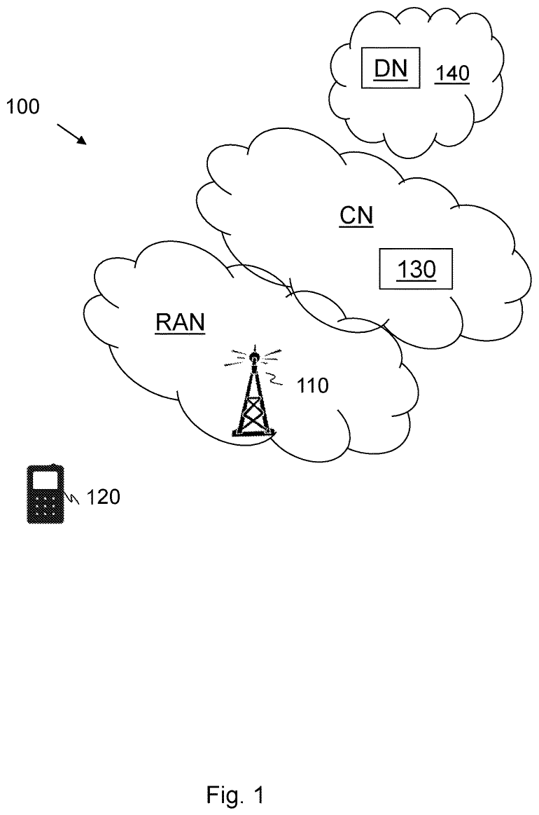

FIG. 1 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, (LTE), LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes such as a network node 110 operate in the wireless communications network 100, by means of antenna beams, referred to as beams herein. The network node 110 e.g. provides a number of cells. The network node 110 may be a transmission and reception point e.g. a radio access network node such as a base station, e.g. a radio base station such as a NodeB, an evolved Node B (eNB, eNode B), an NR

Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a wireless device acting as an access point or a peer in a Device to Device (D2D) communication, or any other network unit capable of communicating with a wireless device within a cell served by the network node 110 depending e.g. on the radio access technology and terminology used.

Wireless devices operate in the wireless communications network 100, such as a wireless device 120. The wireless device 120 may provide radio coverage by means of a number of antenna beams. The wireless device 120 may e.g. be an NR device, a mobile station, a wireless terminal, an NB-IoT device, an eMTC device, an NR RedCap device, a CAT-M device, a WiFi device, an LTE device and an a non-access point (non-AP) STA, a STA, that communicates via a base station such as e.g. the network node 110, one or more Access Networks (AN), e.g. RAN, to one or more core networks (CN). It should be understood by the skilled in the art that the UE relates to a non-limiting term which means any UE, terminal, wireless communication terminal, user equipment, (D2D) terminal, or node e.g. smart phone, laptop, mobile phone, sensor, relay, mobile tablets or even a small base station communicating within a cell.

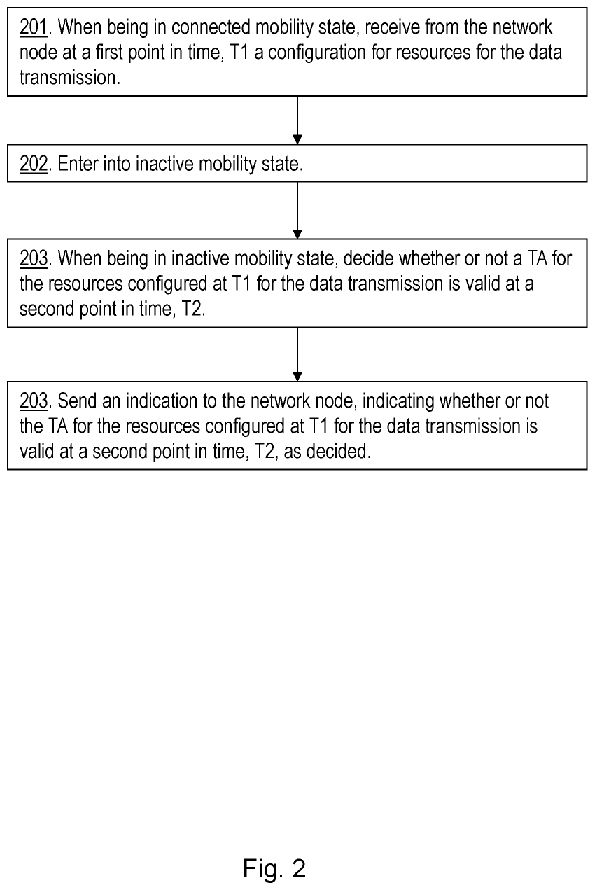

Methods herein may in one aspect be performed by the network node 110, and in another aspect by the wireless device 120. As an alternative, a Distributed Node (DN) and functionality, e.g. comprised in a cloud 140 as shown in FIG. 2, may be used for performing or partly performing the methods.

Some example embodiments herein comprise a method for the wireless device, e.g. UE, as described below.

The embodiments applies to a scenario where the UE is preconfigured with resources such as uplink CG resources for SDT transmissions at time T1 by the serving network node, e.g. NW1, and the transmission may take place provided that TA is evaluated to be valid at time T2. According to an example of the method, the wireless device 120 is configured with at least one rule comprising conditions or criteria for reporting TA evaluation result, e.g. an indication such as information about whether or not a TA is valid, to the network node 110.

According to some first rules, also referred to as rule #0, or a basic idea, the wireless device 120 informs the network node 110 whether or not TA evaluated at T2 was valid, or e.g. whether or not TA evaluated at T2 was invalid.

According to some second rules, also referred to as rule #1, the wireless device 120 informs the network node 110 whether or not TA evaluated at T2 was valid, or e.g. whether or not TA evaluated at T2 was invalid provided one or more conditions or criteria as described in subrules 1-1, 1-2, and rule 1-3 are met.

Rule 1-1: The wireless device 120 informs the network node 110 whether or not TA evaluated at T2 was valid. Or e.g. whether or not TA evaluated at T2 was invalid based on the configured resources, such as the CG resource configuration. The CG resource configuration comprises at least number of PUSCH resources, e.g. CG PUSCH resources, number of beams associated with the CG resources, transmission periodicity using the configured CG resources, also called PUR periodicity. More specifically, the wireless device 120 may inform the network node 110 about the TA evaluation outcome e.g. when being invalid if any one or more out of following conditions are met:

Number of configured CG PUSCH resources>N1; Wherein N1 is a predetermined threshold.

Number of configured beams linked to the resources such as CG PUSCH resources>N2; Wherein N2 is referred to as a second threshold herein.

Transmission occasions/periodicity for using the configured resources such as CG PUSCH resources>K time resources or certain duration (e.g. K1 ms, K2 slots, K3 frames, K4 SFN cycles etc). Wherein K is referred to as a third threshold herein.

Rule 1-2: The wireless device 120 informs the network node 110 that TA is invalid based on whether the invalid TA is caused by any beam changes between time T1 and T2. It may also depend on the number of beam changes. The wireless device 120 informs the network node 110 about the TA evaluation outcome if following condition is met:
TA was evaluated to be invalid due to beam changes occurred between T1 and T2
TA was evaluated to be invalid due to more than Nb number of beam changes have occurred between T1 and T2.

Rule 1-3: The wireless device 120 informs the network node 110 that TA is invalid based on TAT configuration which contains e.g. the TAT timer. The wireless device 120 informs the network node 110 about the TA evaluation outcome if one or more of following conditions are met:

If TA becomes invalid less than T_{d} time before TAT expiry e. g.
T_{d}=((T3-δt2)−(T2±δt1)); where TA becomes invalid at T2 and TAT is configured to expire at T3.
In some examples δt1 correspond to time between T2 and closest PUR occasion in time.
In some examples δt2 correspond to time between T3 and closest PUR occasion in time.
As special case δt1=0 and δt2=0.
configured TAT value is above certain threshold According to some third rules, also referred to as rule #2, the wireless device 120 may inform the network node 110 about the TA evaluation result, e.g. invalid TA, if the wireless device 120 has fulfilled any combination of the rules 1-1, 1-2, and 1-3.

The informing of the result to the network node 110 may be done upon detecting that the TA is invalid and may be of implicit or explicit type. Examples of implicit reporting are that the wireless device 120 indicates that the resources are no more used, beam timing has changed above a threshold, RSRP between the beams has changed. Examples of explicit reporting e.g. comprises that the wireless device 120 indicates to the network node 110 that current TA is invalid, or the wireless device 120 requests the network node 110 to release the configured resources, such as e.g. CG resources.

Advantages with embodiments comprises at least the following:

The configured uplink CG resources are released earlier when the wireless device 120 is not expected to use them.

The uplink resources are more efficiently used especially in FR2 where a lot more resources are preconfigured for each configured transmitting beam. Based on the reporting methods according to embodiments herein, the network node 110 is enabled to detect any reservation or blockage of resources which are not expected to be used by the intended user much earlier and release those resources or reassign them to other wireless devices which are able to use them.

FIG. 2 shows an example method performed by the wireless device 120.

The method is e.g. for handling configured resources for a data transmission to the network node 110 in the wireless communications network 100.

In some embodiments, the method is e.g. for handling configured resources, such as e.g. CG resources, for a data transmission, such as e.g. an SDT, to the network node 110 in the wireless communications network 100.

It should be noted that the wordings “first point in time T1”, “time T1” and the term “T1” are equal and may be used interchangeably herein. Further, the wordings “second point in time T2”, “time T2” and the term “T2” are equal and may be used interchangeably herein.

The method comprises any one or more out of the actions below:

Action 201

When being in connected mobility state, the wireless device 120 receives from the network node 110, a configuration for resources for the data transmission. The configuration for resources is received at a first point in time T1. The data transmission may e.g. be an SDT. The configuration for resources, may e.g. be a configuration for CG resources. This means that the wireless device 120 is configured at the first point in time time T1.

The above may interchangeably be referred to as, when being in connected mobility state, the wireless device 120 receives from the network node 110, a configuration for resources, such as e.g., the CG resources, for the data transmission, e.g. a SDT, at a first point in time, T1.

In some embodiments, the configured resources, such as e.g. CG resources, comprises any one or more out of:
One or more configured PUSCH resources, such as e.g. CG PUSCH, resources,
one or more beams associated with the configured resources, and
transmission periodicity (of the data transmission) using the configured configured resources, e.g. PUR. In some embodiments, this related to any one or more out of Rules 1-1, 1-2, and 1-3.

Action 202

The wireless device 120 enters into inactive mobility state.

Action 203

When being in inactive mobility state, the wireless device 120 decides, e.g. evaluates, whether or not a TA for the resources configured for the data transmission at T1 is valid at a second point in time, T2. In some of these embodiments, this this relates to Rule #0.

In some embodiments, the wireless device 120 decides, e.g. evaluates whether or not the TA for the resources configured for the data transmission at T1 is valid at T2, based on one or more conditions. The conditions may e.g. referred to as criteria. In some of these embodiments, this this relates to Rule #1

In some embodiments, the one or more conditions comprises any one or more out: whether or not the one or more configured resources comprising PUSCH resources, such as e.g. CG PUSCH resources, fulfills a first threshold, e.g. N1, whether or not the one or more beams associated with the resources fulfills a second threshold, e.g. N2, whether or not the transmission periodicity using the configured resources, e.g. preconfigured resources, PUR, fulfills a third threshold, K, e.g. uses more time resources than K wherein the time resources are any one of: milliseconds, slots, frames, and

System Frame Number (SFN) cycles, whether or not the magnitude of change in serving cell RSRP fulfils fourth threshold. In some of these embodiments, this relates to Rule 0 and possibly Rule 1-1.

In some embodiments, the one or more conditions comprises any one or more out: whether or not beam changes occurred for one or more beams associated with the configured resources, between time T1 and time T2, and whether or not a number of beams associated with the configured resources, have changed, e.g. increased or decreased, between time T1 and time T2. In some of these embodiments, this relates to Rule 1-2.

In some embodiments, the one or more conditions are based on a timer, e.g. TA

Timer, TAT, which timer expires at a third point in time, T3, and wherein the one or more conditions comprises any one or more out:

whether or not the difference between time T2 and time T3 fulfills, e.g. exceeds, a fifth threshold,

whether or not T3-δt2-T2±δt1 fulfills, e.g. exceeds, a sixth threshold; wherein the TA becomes invalid at T2 and TAT is configured to expire at T3, e.g. wherein δt1 correspond to time between T2 and closest PUR occasion in time and/or wherein δt2 correspond to time between T3 and closest PUR occasion in time, T_{d}=difference between T2 and T3, and T3=T3-δt2-T2±δt1, and whether or not T3 fulfills, e.g. exceeds, a seventh threshold.

In some of these embodiments, this relates to Rule 1-3.

In some embodiments, the wireless device 120 decides, e.g. evaluates whether or not the TA for the resources configured for the data transmission at T1 is valid at T2, based on one or more conditions, e.g. referred to as criteria. In some of these embodiments, this this relates to Rule #2.

In these embodiments, the one or more conditions comprises any one or a combination of: Rule 1-1, 1-2, 1-3.

Action 204

The wireless device 120 sends an indication to the network node 110. The indication indicates whether or not the TA for the resources configured for the data transmission at T1 is valid at a second point in time, T2, as decided.

In some embodiments, the wireless device 120 sends the indication to the network node 110 only when it has been decided that the TA for the resources configured for the data transmission at T1 is not valid at T2.

Thus, in these embodiments, the indication to the network node 110, is sent when it has been decided that the TA for the resources configured at T1 for the data transmission is not valid at T2, and which indication indicates that the TA is not valid at T2. In other words, in these embodiments, the indication to the network node 110, is sent when it has been decided that the TA for the resources configured for the data transmission at T1 is not valid at T2, and which indication indicates that the TA is not valid at T2.

In some embodiments, the wireless device 120 sends the indication to the network node 110, by sending an explicit or implicit indication.

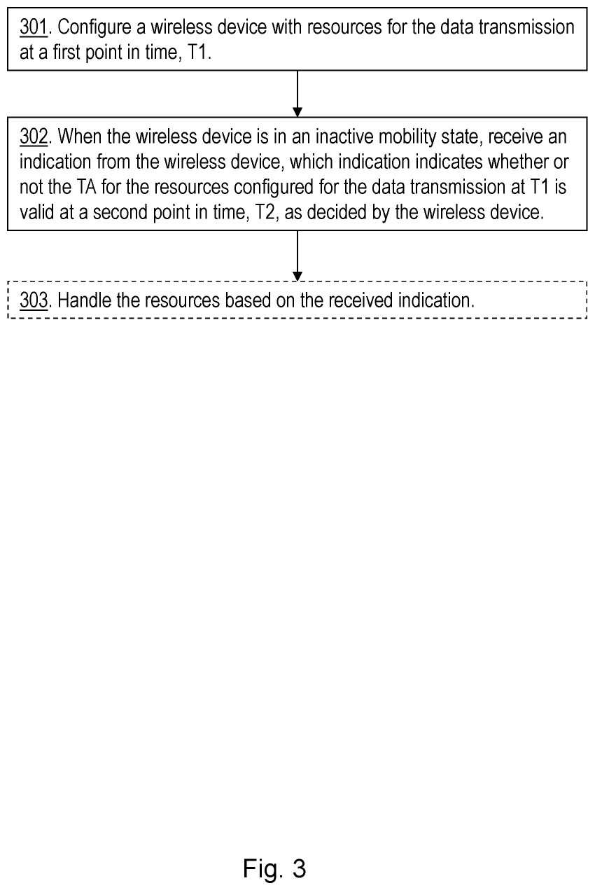

FIG. 3 shows an example method performed by the network node 110 for handling, e.g. controlling, resources for a data transmission. The resources may e.g. be CG resources. The data transmission may e.g. be an SDT.

The method comprises any one or more out of the actions below:

Action 301

The network node 110 configures the wireless device 120 at a first point in time T1, with resources for the data transmission. This may interchangeably be referred to as the network node 110 configures the wireless device 120 with resources for the data transmission at a first point in time, T1. This means that wireless device 120 is configured at the first point in time T1. The resources may e.g. CG resources and the data transmission may e.g. be an SDT.

The data transmission is from the wireless device 120 to the network node 110 in the wireless communications network 100.

Action 302

When the wireless device 120 is in an inactive mobility state, the network node 110 receives an indication from the wireless device 120.

The indication indicates whether or not the TA for the resources configured at T1 for the data transmission is valid at a second point in time, T2, as decided by the wireless device 120. This may interchangeably be referred to as the indication indicates whether or not the TA for the resources configured for the data transmission at T1 is valid at a second point in time, T2, as decided by the wireless device 120.

As mentioned above, in some embodiments, to the network node 110 receives the indication when the wireless device 120 has decided that the TA for the resources configured for the data transmission at T1 is not valid at T2, and which indication indicates that the TA is not valid at T2.

Action 303

The network node 110 handles, e.g. controls, the resources based on the received indication. The resources may e.g. CG resources.

In some embodiments, the network node 110 handles the resources, by any one or more out of: Releasing the configured resources for data transmission and/or configuring the released resources to one or more other wireless devices.

The method will now be further explained and exemplified in below embodiments. These below embodiments may be combined with any suitable embodiment as described above.

Some embodiments relate to methods for releasing CG-SDT resources under TA invalidation.

Example of embodiments herein may relate to methods for releasing CG-SDT resources under TA invalidation. CG, TA, SDT, SSB, PUSCH, New Radio (NR), RRC Inactive.

### Terminology

In some embodiments a more general term “network node” is used and it may correspond to any type of radio network node or any network node, which communicates with a UE and/or with another network node. Examples of network nodes are radio network node, gNodeB (gNB), ng-eNB, base station (BS), NR base station, TRP (transmission reception point), multi-standard radio (MSR) radio node such as MSR BS, network controller, radio network controller (RNC), base station controller (BSC), relay, access point (AP), transmission points, transmission nodes, RRU, RRH, nodes in distributed antenna system (DAS), core network node (e.g. MSC, MME, etc), O&M, OSS, SON, positioning node or location server (e.g. E-SMLC), MDT, test equipment (physical node or software), etc.

In some embodiments the non-limiting term user equipment (UE) or wireless device is used and it refers to any type of wireless device communicating with a network node and/or with another UE in a cellular or mobile communication system. Examples of UE are wireless device supporting NR, target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), drone, USB dongles, ProSe UE, V2V UE, V2X UE, etc.

The term “radio node” may refer to radio network node or UE capable of transmitting radio signals or receiving radio signals or both.

The term radio access technology, or RAT, may refer to any RAT e.g. UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The UE performs measurements on reference signal (RS). Examples of RS are discover signal or discovery reference signal (DRS), SSB, CSI-RS, CRS, DMRS, PSS, SSS etc. Examples of measurements are cell identification (e.g. PCI acquisition, cell detection), Reference Symbol Received Power (RSRP), Reference Symbol Received Quality (RSRQ), secondary synchronization RSRP (SS-RSRP), SS-RSRQ, Singal to Interference Noise Ratio (SINR), RS-SINR, SS-SINR, CSI-RSRP, CSI-RSRQ, acquisition of system information (SI), cell global ID (CGI) acquisition, Reference Signal Time Difference (RSTD), UE RX-TX time difference measurement, radio link quality, Radio Link Monitoring (RLM), which consists of Out of Synchronization (out of sync) detection and In Synchronization (in-sync) detection, Layer-1 RSRP (L1-RSRP), Layer-1 SINR (L1-SINR) etc.

The terms small data transmissions (SDT), transmissions using configured grant configured PUSCH resources in RRC inactive and/or RRC idle state, and transmissions using preconfigured uplink resources (PUR) are interchangeably used. In this context, both refer to transmissions using preconfigured uplink resources in one or more uplink channels (e.g. PUSCH, PUCCH, PRACH). In some examples, PUR and transmission using CG resources are interchangeably used. PUR transmission may therefore also be called as data transmission, SDT transmission, CG based SDT transmission (e.g. CG-STD transmission etc).

The terms sending an indication, reporting, informing, and signalling to the network node 110 are interchangeably used throughout this document. PUR periodicity, or transmission occasions using PUR, or transmission occasions using CG resources are interchangeably used.

Scenario for Configuring and Validating TA for Data Transmission Such as SDT Transmission

The configured resources may be the CG resources or a CG configuration. The configured resources are e.g. associated with two or more downlink reference signals. In some examples the wireless device 120 may be configured with the association or relation or link between DL RSs, e.g. SSBs, and the configured resources, such e.g. the

CG resources in the same message containing the resource configuration such as the CG configuration (e.g. RRC connection release) or in different message. In some other embodiments, the association or relation or link between DL RSs, e.g. SSBs, and the configured resources, such e.g. the CG resources may be pre-defined or pre-configured in the wireless device 120. Examples of DL RS are SSB, CSI-RS etc. Each DL RS may be transmitted by the cell of the network node 110 in one or more time-frequency resources. For example, one SSB is transmitted over 4 symbols and over 20 RBs etc. Each DL RS, e.g. SSB, may interchangeably be called as a DL beam, spatial filter, spatial domain transmission filter, main lobe of the radiation pattern of antenna array etc. The RS or beams may be addressed or configured by an identifier, which may indicate the location of the beam in time in beam pattern e.g. beam index such as SSB index indicate SSB beam location in the pre-defined SSB format/pattern. For example, the term beam used herein may refer to RS such as SSB, CSI-RS etc.

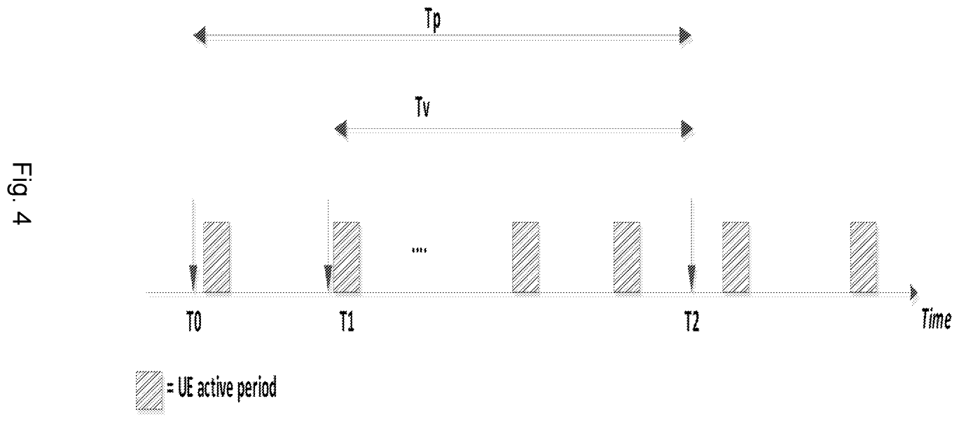

FIG. 4 is a schematic diagram depicting transmission when using preconfigured uplink resources in time domain. The X-axis of the diagram represents time. The diagonally striped boxes represent time when the wireless device 120 is active. The wireless device 120 is referred to as UE. The TA validation scenario, more specifically, the important steps involved in time domain is illustrated in FIG. 4. In FIG. 4, depicts the first point in time T1 when the TA for the resources was configured. T1 is the time when TA was obtained by the wireless device 120 from the network node 110, e.g. serving network node gNB/eNB, the TA value was updated or the resource configuration comprising the TA value was obtained by the wireless device 120. The corresponding serving beam is denoted by a first beam (B₀). This relates to and may be combined with Action 201 and Action 301 described above.

The signal level may comprise a signal measurement performed by the wireless device 120 on one or more reference signals (RS) transmit by the serving cell. Examples of signal measurements are RSRP, RSRQ, SI NR, Signal to Noise Ratio (SNR) etc. Examples of RS are SSB, CSI-RS, PRS, DMRS etc. The signal measurement may also be called as beam signal measurement or simply beam measurement etc.

In some examples the serving beam may be one of the beams within the configured set of beams associated with CG configuration. In some other examples the serving beam is the one used for TA validation. In some other examples the wireless device 120 may select any of the beams within the configured set of beams associated with CG configuration, as its serving beam. In some other examples the wireless device 120 may determine the serving beam based on a relation between the measured signal level and a beam measurement threshold (Bt); the relation may be pre-defined, configured by the network node 110 or determined by the wireless device 120 autonomously. In some other examples the serving beam is the one whose signal measurement is above Bt. In another example the serving beam is the one whose signal measurement is at least X dB above Bt (expressed also in log scale). In case of multiple beams, the serving beam may be the one which has largest signal measurement level among all beams and is also above Bt or X dB above Bt. Parameters X and Bt may be pre-defined and/or configured by the network node 110.

Similarly, T2 may be the time when the TA validation is performed. The corresponding serving beam is denoted by a second beam (B₁).

Tv, as shown in FIG. 4, is the time between last TA evaluation/validation or time when last TA was received/updated and the time when current TA validation is performed. This time period depends on e.g. when the wireless device 120 has been paged last time, when the wireless device 120 has switched to the RRC_CONNECTED state last time, PUR periodicity, traffic/data/service type. FIG. 4 also shows the Tp which is the PUR periodicity, i.e. last PUR occasion occurred at time T0 and the new occurrence is at time T2. Similar to Tv, the Tp may depend on several factors including when UE has been paged last time, when UE has switched to the RRC_CONNECTED state last time, PUR periodicity, traffic/data/service type. TA validation is performed by the wireless device 120 when the wireless device 120 higher layers trigger the transmission of data using PUR resources. Therefore prior to transmission the wireless device 120 needs to validate whether the previously received TA is still valid or not. The wireless device 120 transmits in UL using PUR resources only if the wireless device 120 determines that the TA is valid.

Otherwise, it refrains from transmitting using the preconfigured resources.

This relates to and may be combined with Action 203 and Action 204 described above.

The wireless device 120 may be configured with one or more TA validation methods. The methods used for validating the TA is configured by the serving network node 110 or preconfigured by the operator or a third node which is different from the serving network node. Alternatively, it may be specified as a rule in specification. Examples of methods that may be used for TA validation are based on:
Serving cell changes e.g. TA becomes invalid upon the changing of the wireless device 120's serving cell; otherwise the TA is considered valid.
Serving beam changes e.g. if at least N number of serving beams are changed then TA becomes invalid; otherwise the TA is considered valid. As special case N=1.
Change in strongest beam. This method is based on changes in strongest beam e.g. strongest beam is one with largest RSRP of all the beams in the configured set. For example, if the wireless device 120's strongest beam changes then the TA becomes invalid; otherwise the TA is valid. In another example if the wireless device 120's strongest beam is changed but it still belongs to the configured set of the beams then the TA is considered valid; otherwise the TA is considered invalid.
Timer based validation e.g. upon receiving TA value the wireless device 120 starts a timer and upon its expiry the TA becomes invalid.
Serving cell measurement (e.g. RSRP) changes e.g. based on signal level change (e.g. RSRP change). In this case for example the TA is considered to be valid if the magnitude of the difference between the RSRP measured (RSRP1) at or around time (T1) when TA was configured and the RSRP measured (RSRP2) at or around time (T2) when TA is being validated (for data transmission), is below or equal to certain threshold (G); otherwise the TA is invalid. The RSRP may be beam level or cell level as explained below:
   In some examples, the RSRP used for RSRP based TA validation, may be measured per beam (e.g. per SSB). In this case the wireless device 120 may check TA validation for each beam separately. If the TA is valid for at least one beam based on its RSRP change (i.e. magnitude of RSRP change threshold for at least one beam) then the TA is valid; otherwise the TA is invalid.
   In some other examples, the RSRP used for RSRP based TA validation, may be measured on cell level (e.g. average RSRP of 1 or more SSBs). In this case the wireless device 120 may check TA validation for all beams together e.g. based on average RSRP of all beams. If the magnitude of cell level RSRP change threshold then the TA is valid; otherwise the TA is invalid.

### Example Embodiments Involving Methods in the Wireless Device 120 for Sending the Indication Indicating, e.g. Informing, the Decided TA Validity Associated with Configured Data Transmission, e.g. CG-SDT Transmissions

The methods in the wireless device 120 for informing the network node 110, also referred to as NW1, about TA invalidity may be based on one or more rules as described below.

According to a first rule (rule #0), the wireless device 120 may perform the TA validation as described above at time T2 and informs the network node 110 whether or not TA evaluated at T2 was valid, or e.g. whether or not TA evaluated at T2 was invalid, e.g. in case if TA is evaluated to be invalid. As described above, the wireless device 120 may be required to always validate the TA before transmitting using the configured resources, such as the CG resource configuration, and the said validation is performed at time T2 in FIG. 4. The rationale of informing the network node 110 now about invalid TA is that the network node 110 may use it to adapt the configured resources, such as the CG resource configuration allocation; adapting herein comprises releasing, reassigning, suspending or postponing the configuration or the resources. For example, the released or suspended resources may be assigned by the network node 110 to one or more other wireless devices in the cell of the network node 110. In addition to reducing signaling overhead and redundant information when reporting only invalid TA, no adaption of resources is needed if TA is evaluated to valid, in this case the old or the current resource configurations may be assumed to be still valid.

The wireless device 120 may further be configured by the network node 110 to inform the results of the TA validation within a certain time period after the wireless device 120 has determined the TA as invalid e.g. inform the network node 110 within ΔT2′ where:

ΔT2′=(T2′−T2)

### Where:

T2′ is the time by which the wireless device 120 is required to inform that the TA was determined (at T2) to be invalid.

The wireless device 120 may further inform the network node 110 about one or more reasons for TA invalidation e.g. TA was invalid due to TAT expiry, due to magnitude of change in serving cell RSRP above threshold, due to change in number of beams above threshold etc.

According to a second rule (rule #1), which may be divided into three sub-rules (rule 1-1, 1-2, and 1-3), the wireless device 120 may perform the TA validation as described above at time T2 and informs the network node 110 whether or not TA evaluated at T2 was valid, or e.g. whether or not TA evaluated at T2 was invalid, in some embodiments if TA is invalid provided, one or more conditions or criteria as described in rules 1-1, rule 1-2, rule 1-3 are met. The sub-rules are described in more detail below.

Rule 1-1: The wireless device 120 informs the network node 110 that TA is invalid based on the configured resources, such as the CG resource configuration, which comprises at least:
number of configured resources e.g. CG PUSCH resources.
   The CG PUSCH resources are described above. The number of PUSCH resources may be expressed using e.g. PUSCH repetition type, number of repetitions (number of slot aggregation), number of consecutive PUSCH symbols configured or allowed for data transmission such as CG transmission, number of PUSCH symbols for configured resources, such as the CG resource configuration, or allowed over a period of time (e.g. X ms, N DRX cycles) etc.
number of beams associated with the configured resources, such e.g. the CG resources;
   As described above, there may be up to 8 SSBs in licensed FDD bands and 64 SSBs in licensed TDD bands corresponding to 8 DL beams and 64 DL beams respectively. Similarly, the wireless device 120 may also be associated with multiple transmission beams, or uplink beams for transmitting the PUSCH over the configured resources, such e.g. the CG resources. For example, if the wireless device 120 is configured with 8 transmission beams, then 8 different configured resources, such as the CG resource configurations are needed. Similarly, if the wireless device 120 is configured with 64 transmission beams, then 64 different configured resources, such as CG resource configurations, are needed, although the configurations may not always be fully non-overlapping.
Configured resource transmission such as CG based transmission periodicity;

The PUR transmission periodicity or CG based transmission periodicity e.g. indicates when the Data transmission such as the SDT transmission may occur. For example, a smaller value of PUR periodicity indicates that Data transmission such as the SDT transmission may take place more frequently than when it is configured with a longer PUR periodicity. It is more beneficial to report about the invalid TA when the periodicity is smaller than threshold (e.g. below 8 seconds) because then more resources are expected to be unused by the wireless device 120.

If TA is evaluated to be invalid, then the wireless device 120 may inform the network node 110 that the TA is invalid if one or more of following conditions are met; otherwise the wireless device 120 informs does not inform NW1 about TA validity or invalidity:
Number of configured PUSCH, such as CG PUSCH, resources>N1;
   In some examples, if the number of PUSCH, such as CG PUSCH, repetitions>N11
   In another example, if PUSCH, such as CG PUSCH, aggregation level>N12.
   In yet another example, if PUSCH, such as CG PUSCH, transmission occasions comprise more than N13 consecutive PUSCH resources (e.g. symbols, slots).
   In yet another example, if PUSCH, such as CG PUSCH, configurations comprise more than N14 PUSCH resources over a certain time duration (e.g. X1 ms, X2 DRX cycles, X3 slots etc).

Number of configured beams linked to the PUSCH, such as CG PUSCH, resources>N2.

Transmission occasions/periodicity using configured PUSCH, such as CG PUSCH, resources are larger than certain threshold e.g. larger than any one or more of K1 ms, K2 DRX cycles, K3 slots etc.

where parameters N1, N11, N12, N13, N14, X1, X2, N2, K1, K2 and K3 may be configurable, preconfigured or predefined.

Rule 1-2: The wireless device 120 indicates to, e.g. informs the network node 110 whether or not TA evaluated at T2 was valid, or e.g. whether or not TA evaluated at T2 was invalid, informs the network node 110 that TA is invalid based on the information related to beam changes. The beam changes may comprise whether any beam changes have occurred between time T1 and T2, and also the number of beam changes.

The serving beams at time T1 and T2 are denoted as B₀ and B₁ as above.

If the serving beam of the wireless device 120 at T2 is the same as it was at T1 then the wireless device 120 assumes that the beam has not changed. This may be represented by the following expression: B₀=B₁. But if the serving beam of the wireless device 120 at T2 is different than the serving beam at T1 then the wireless device 120 assumes that at least one beam has changed. This may be represented by the following expression: Boy B1. The serving beam may have changed for different reasons such as changes in the wireless device 120's geographical position, changes in radio conditions (e.g. increased interference), changes network configuration (e.g. number of beams reconfigured, different power settings, etc. resulting in another beam's signal level becomes larger than that of the previous serving beam, or if it becomes larger than threshold Bt.

In one exemplary embodiment of rule 1-2, if TA is evaluated to be invalid and beam changes has occurred between T1 and T2, then the wireless device 120 informs the network node 110 that TA is invalid.

In another exemplary embodiment of rule 1-2, if TA is evaluated to be invalid, and if the serving beam has changed between T1 and T2, by at least a threshold (e.g. K number of beam changes or if UE has had K number of serving beams between T1 and T2) then the wireless device 120 may inform the network node 110 that TA is invalid. Otherwise, the wireless device 120 does not perform any reporting. The parameter K may be pre-defined or configured by the network node 110. As special case K=1.

In yet another exemplary embodiment of rule 1-2, if TA is evaluated to be invalid, and if the serving beam has not changed between T1 and T2, by at least a threshold (e.g. K number of beam changes or if the wireless device 120 has had K number of serving beams between T1 and T2) then the wireless device 120 does not perform any reporting that TA is invalid.

In yet another exemplary embodiment of rule 1-2, if TA is evaluated to be invalid, and if B₀=B, but the wireless device 120 has had more than a certain number (K) of serving beams between T1 and T2, or if UE has changed beam more than a certain number of times (K), then the wireless device 120 may inform the network node 110 that TA is invalid. The parameter K may be pre-defined or configured by the network node 110. As special case K=1.

Rule 1-3: This rule is based on the TAT configuration which is described in above The configuration comprises a timer, which may be called timeAlignmentTimer, which may be configured to different values such as e.g. ms500, ms750, ms1280, ms1920, ms2560, ms5120, ms10240, infinity. It is noted that the TAT timer may be independently configured and is not always linked to the configured resources, such as e.g. configured CG resources. Consequently, there are cases where the TAT timer expires before the transmission using the resources take place and vice versa.

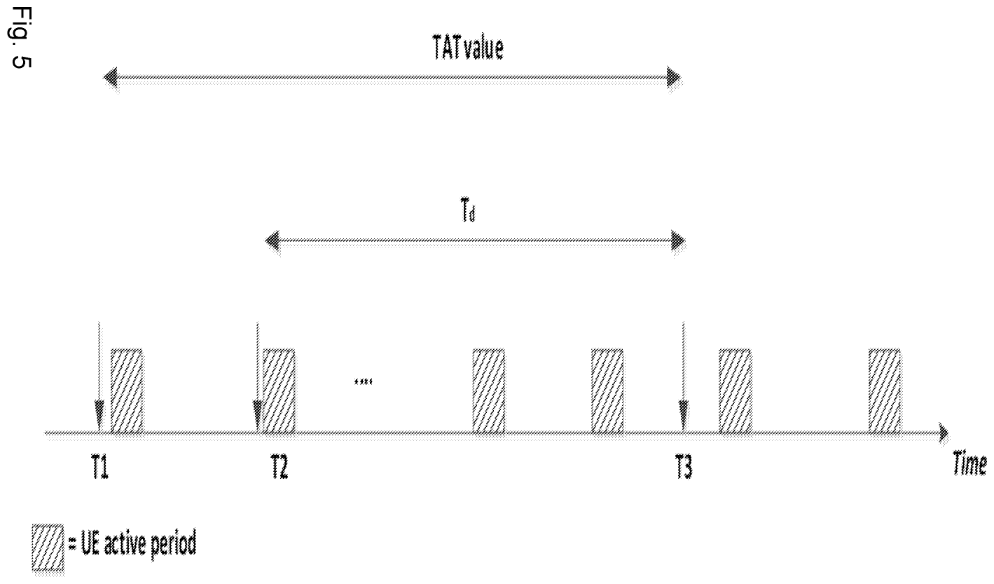

This subrule is targeting the problem of the wireless device 120 is prohibited to transmit using configured resources, such as CG resources because TA value is evaluated to be invalid. This has multiple consequences. In some examples, the configured resources, such e.g. the CG resources, become reserved or blocked until the TAT timer expires and only then the network node 110 may release those resources. As noted above, TAT value may be set to large values such as e.g. 5120 ms, 10240 ms, or infinity. This means, the configured resources, such as e.g. configured CG resources become blocked for long time without any network knowledge making it difficult to reassigning, suspending or postponing the configuration or the resources. Following this rule, upon TA is evaluated to be invalid at time T2, the reporting to the network node 110 may be based on the remaining time, noted as T_{d}, until TAT expires at time T3, see FIG. 5. FIG. 5 is a schematic diagram depicting the relation between TA validation and TAT expiry. The X-axis of the diagram represents time. The diagonally striped boxes represent time when the wireless device 120 is active. The wireless device 120 is referred to as UE.

In one general example the wireless device 120 may decide, also referred to as determine, whether to report that the TA is invalid to the network node 110 based on:
A relation between the amount of time remaining for TAT expiry from the moment the TA validation is done by the wireless device 120 (T_{d}) and a threshold (Th1). The relation may be pre-defined or configured by the network node 110.

Where:
T_{d}=correspond to the amount of time remaining for TAT expiry from the moment the TA validation is done by the wireless device 120. T_{d} may be expressed in terms of certain number of time resources e.g. TAT value, PUR periodicity/CG transmission occasions, DRX cycle length etc.

In one specific example if the TA is determined to be invalid then the wireless device 120 reports to NW1, such as the network node 110, that TA is invalid if the following condition is met:
If T_{d} Th1

Otherwise (when T_{d}<Th1) then the wireless device 120 may refrain from informing the network node 110 about invalid TA value. This is because reporting requires the wireless device 120 to initiate connection with NW1 e.g. by sending random access (RA). But when T_{d} is small then TAT is going to expiry soon therefore in this case avoiding informing reduces signaling and power consumption.

Th1 is a configurable or predefined threshold which may depend on e.g. TAT value, PUR periodicity/CG transmission occasions, DRX cycle length etc. In some examples, T_{d} may be defined as follows:
T_{d}=((T3-8t2)−(T2±δt1)); where TA becomes invalid at T2 and TAT is configured to expire at T3.
   In some examples δt1 corresponds to time between T2 and closest PUR occasion in time.
   In some examples δt2 corresponds to time between T3 and closest PUR occasion in time.
   As special case δt1=0 and δt2=0.

In some other examples, whether the wireless device 120 reports to the network node 110 that TA is invalid based on the configured TAT value. For example, the wireless device 120 may decide, e.g. determine, whether to report to the network node 110 that the TA is invalid based on a relation between the configured TAT value and a threshold. The relation may be pre-defined or configured by the network node 110. The rationale is the configured resources, such e.g. the CG resources become blocked or reserved for longer time due to invalid TA when TAT is set to a large value compared to when it is set to a small value. In some specific examples, the reporting condition based on relation between the configured TAT value and threshold may be specified as follows:
If TAT value Th2 then the wireless device 120 reports that the TA is invalid (if the TA is determined to be invalid),

Where Th2 is a configurable or predefined threshold.

Otherwise (TAT value<Th2), the wireless device 120 may choose to not report to the network node 110 about status of TA value.

According to a third rule (rule #2), the wireless device 120 indicates to, e.g. informs, the network node 110 whether or not TA evaluated at T2 was valid, or e.g. whether or not TA evaluated at T2 was invalid, such as e.g. that TA is invalid, if it has fulfilled any combination of the subrules rule 1-1, 1-2 and 1-3.

In a first example, the wireless device 120 informs the network node 110 that TA is invalid if the wireless device 120 has fulfilled at least one of the criteria or conditions explained in rule #1, i.e. sub-rules rule 1-1, 1-2 and 1-3.

In a second example, the wireless device 120 informs the network node 110 that TA is invalid if the wireless device 120 fulfills at least any two of the three criteria or conditions explained in rule #1, i.e. any two of the sub-rules rule 1-1, 1-2 and 1-3.

In a third example, the wireless device 120 informs the network node 110 that TA is invalid if the wireless device 120 fulfills all the criteria or conditions explained in rule #1, i.e. UE meets the all the conditions and rules in sub-rules rule 1-1, 1-2 and 1-3.

### Example Embodiments Involving Methods to Indicate to, e.g. Inform, Network Node 110 about TA Determining, e.g. TA Evaluation, Outcome

In some examples the wireless device 120 sends random access to the network node 110 to establish the connection with the network node 110 e.g. at the next RA opportunity. After establishing the connection with the network node 110 the wireless device 120 sends results of the TA validation whether or not TA evaluated at T2 was valid, such as e.g. whether or not TA evaluated at T2 was invalid, or an indication that the TA is invalid if the TA was determined to be invalid. This indicates that the wireless device 120 will not use the configured resources, such as e.g. configured CG resources, anymore etc.

In another example the wireless device 120 may be configured to use particular type of random access (e.g. 2 step RA, 4 step RA etc.) to the network node 110 to establish the connection with the network node 110, e.g. at the next RA opportunity. The wireless device 120 may also be configured to send results of the TA validation (e.g. indicating that the TA is invalid if the TA was determined to be invalid and/or CG resources will not be used by the wireless device 120 etc) in the payload of the RA e.g. in PUSCH of message A of 2-step RA.

Another option for the Random Access based reporting is to use RA resources configured for Beam Failure Recovery (BFR). In this case the wireless device 120 is configured with dedicated preambles (per beam) to indicate a best beam. In case the TA is determined as invalid, the wireless device 120 triggers the RA procedure and transmits the preamble corresponding to the new best beam on the BFR RA resources. The network node 110 may then from the reception of the preamble deduce that the wireless device 120s currently used beam does not satisfy the TA validation criteria and which beam is now the best beam. This option may be implemented by including a BeamFailurRecoveryConfig IE in the RRCRelease message sent to the wireless device 120 when configuring the resources such as the CG resources.

In another example the wireless device 120 sends a message at the next Data transmission such as the SDT transmission occasion using e.g. any CG resources, the results of the TA validation e.g. indicating that the TA is invalid if the TA was decided to be invalid, indicating that the wireless device 120 will not use the configured resources, such as e.g. the configured CG resources, anymore etc.

In one option when the message is sent on a CG resource where the TA has become invalid the wireless device 120 sends the message with higher power and a more robust MCS to enhance the reception performance at the network node 110. Using a different MCS will force the network node 110 to use blind decoding of MCS, since it does not know the MCS that will be used in the CG transmission opportunity.

Another option for reporting an invalid TA is to trigger a warning message before the TA becomes invalid, i.e. by using more stringent conditions than what is used for the normal TA validation. In this case, the CG resource still has a valid TA when the warning message is sent but the network node 110 may start using blind decoding of MCS since it may soon receive a message indicating invalid TA using a different MCS. In this way, the extra burden of doing blind decoding is minimized since it is only used after the network node 110 has received the warning message.

Message for reporting TA invalidation or validation

The wireless device 120 may further include additional information related to the TA validation or TA invalidation in the report to the network node 110 using any of the above reporting methods (Random access based or CG based) e.g. additional information may comprise one or more of the following:
information (e.g. identifiers) about TA validation methods used by the wireless device 120 for validating the TA,
information (e.g. identifiers) about TA validation methods based on which the TA was determined to be invalid,
information (e.g. identifiers) about TA validation methods based on which the TA was determined to be valid.

The message containing information of TA validation or TA invalidation may be of different forms. There are several options for this.

Option 1: Use an Unused Logical Channel Identity (LCID) in the Fixed Size R/Lcid Mac Subheader.

In some embodiments herein, the indication of invalid TA is coded by a new LCID in the R/LCID header. As seen from Table 6.2.1-2a in 3GPP TS 38.321, the index 35-44 are reserved and thereby unused.

TABLE 6.2.1-2
Values of LCID for UL-Shared Channel (UL-SCH)

| Code- | |
|---|---|
| point/ | |
| Index | LCID values |
| 0 | Common Control Channel (CCCH) of size 64 bits |
| | (referred to as “CCCH1” in TS 38.331 [5]) |
| 1-32 | Identity of the logical channel |
| 33 | Extended logical channel ID field |
| | (two-octet extended Logical Channel ID (eLCID) field) |
| 34 | Extended logical channel ID field |
| | (one-octet eLCID field) |
| 35-44 | Reserved |
| 45 | Truncated Sidelink Buffer Status reporting (BSR) |
| 46 | Sidelink BSR |
| 47 | Reserved |
| 48 | Listen-Before-Talk (LBT) failure (four octets) |
| 49 | LBT failure (one octet) |
| 50 | BFR (one octet Cᵢ) |
| 51 | Truncated BFR (one octet Cᵢ) |
| 52 | CCCH of size 48 bits |
| | (referred to as “CCCH” in TS 38.331 [5]) |
| 53 | Recommended bit rate query |
| 54 | Multiple Entry Power Headroom Report (PHR) (four octets Cᵢ) |
| 55 | Configured Grant Confirmation |
| 56 | Multiple Entry PHR (one octet Cᵢ) |
| 57 | Single Entry PHR |
| 58 | C-RNTI |
| 59 | Short Truncated BSR |
| 60 | Long Truncated BSR |
| 61 | Short BSR |
| 62 | Long BSR |
| 63 | Padding |

In some examples, using index 35 (or any one of the reserved values 35-44) as LCID in the R/LCID MAC Subheader may be used for this indication. In this embodiment, no MAC CE is used, instead the indication is done by the R/LCID MAC Subheader alone. The the network node 110 would from receiving this R/LCID MAC Subheader and the indicated LCID value understand that the wireless device 120 has an invalid TA.

Option 2: Use an unused eLCID in the R/LCID or R/F/LCID MAC Subheader

In another embodiment, using LCID of 33 or 34 in the R/LCID MAC Subheader and a new eLCID is used to indicate TA invalidity. Wherein R/LCID means a MAC subheader with only reserved bits and LCID and R/F/LCID means a MAC subheader with reserved bit, format field and LCID.

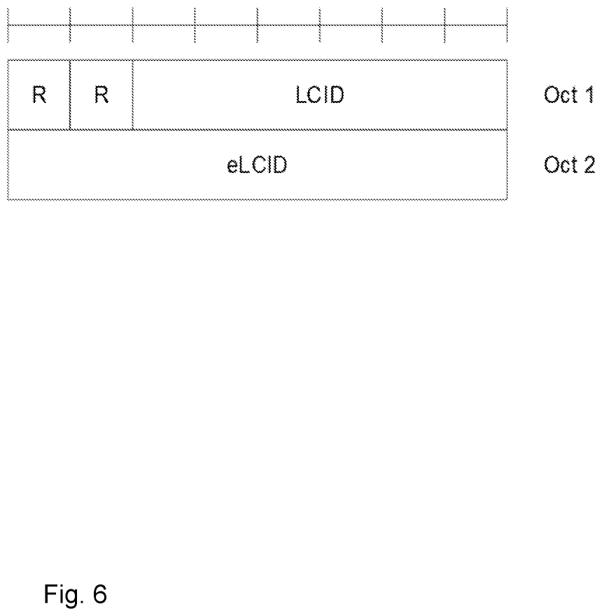

In some examples, LCID=34 is used in the R/LCID/(eLCID) MAC subheader to indicate at one octet eLCID (Octet (Oct) 2) and fixed size payload size, see FIG. 6.1.2-3 from 3GPP TS 38.321 depicted in FIG. 6. FIG. 6 depicts FIG. 6.1.2-3 of 3GPP TS 38.321, R/LCID/(eLCID) MAC subheader. FIG. 6 depicts two octets of the R/LCID/(eLCID) MAC subheader. The scale on top of the octets of FIGS. 6, 7 and 8 marks the bits in the 8-bits long octets 1 and 2 and R is the reserved bit.

In this case the fixed size of the payload may be 0 and only the invalidity of TA is signalled. Other fixed values may be specified e.g in e.g. 3GPP TS 38.321, and used to enable signalling of more information.

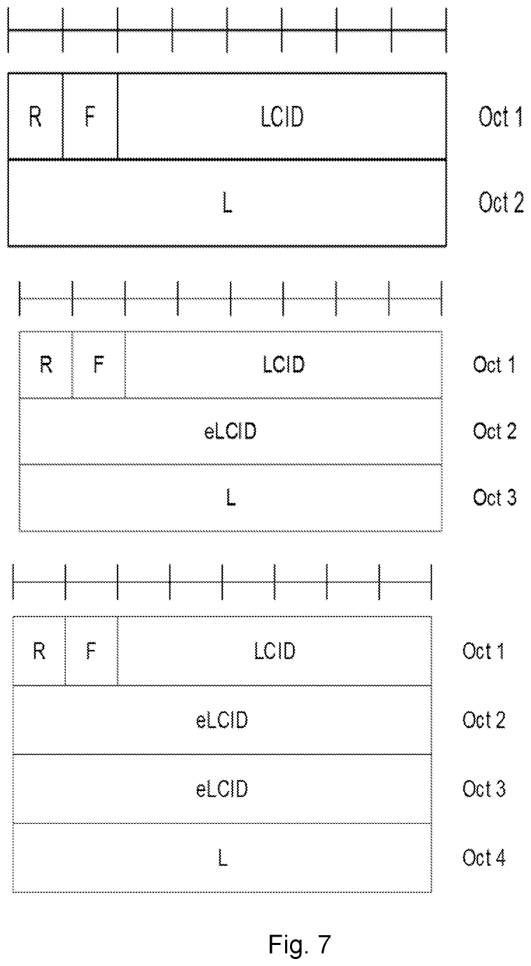

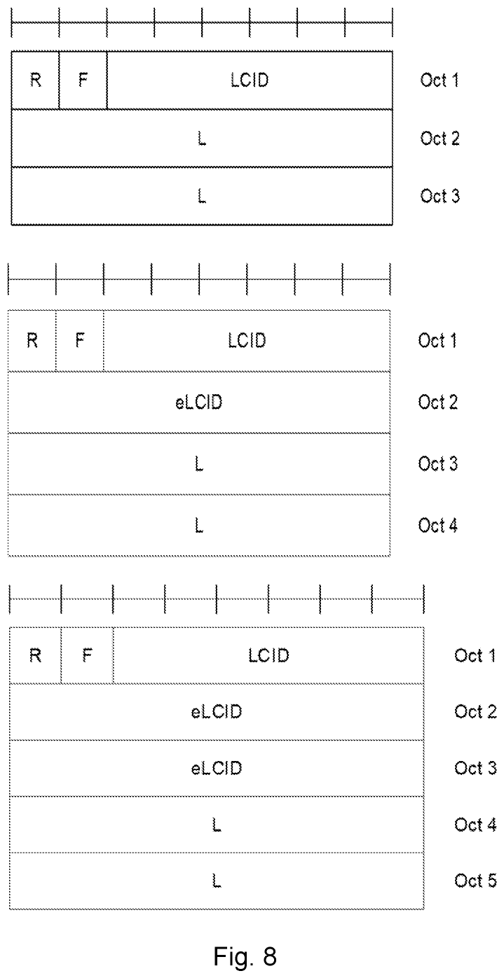

In another example, R/F/LCID/(eLCID)/L MAC subheader is used. This is based on the existing R/F/LCID/(eLCID)/L in FIG. 6.1.2-1 depicted in FIGS. 7, and 6.1.2-2 depicted in FIG. 8, in 3GPP TS 38.321, for example v.16.3.0.

FIG. 7 depicts FIG. 6.1.2-1 of 3GPP TS 38.321, illustrating R/F/LCID/(eLCID)/L MAC subheader with 8-bit L field. FIG. 7 depicts three variants of MAC subheaders that may be used to encode an invalid TA.

FIG. 8 depicts FIG. 6.1.2-2 of 3GPP TS 38.321, R/F/LCID/(eLCID)/L MAC subheader with 16-bit L field. FIG. 8 depicts four variants of MAC subheaders that may be used to encode an invalid TA.

The subheader is then used to indicate invalidity of TA and other information. In some examples, LCID=34 (one octet eLCID field) and a 8-bit L field is used. In this case a new eLCID is used to indicate TA information and the L field may be coded to indicate indicate invalidity of TA and other information.

In some examples, LCID=33 (two octet eLCID field) and a 8-bit L field is used. In this case a new eLCID is used to indicate TA information and the L field may be coded to indicate indicate invalidity of TA and other information.

In another example, LCID=34 (one octet eLCID field) and a 16-bit L field is used In this case a new eLCID is used to indicate TA information and the L field may be coded to indicate indicate invalidity of TA and other information.

In another example, LCID=33 (two octet eLCID field) and a 16-bit L field is used. In this case a new eLCID is used to indicate TA information and the L field may be coded to indicate indicate invalidity of TA and other information.

Option 3: Define a New RRC Message

As a third option, a new RRC message is defined. The message may be based on already existing RRC IEs such as MeasResults.

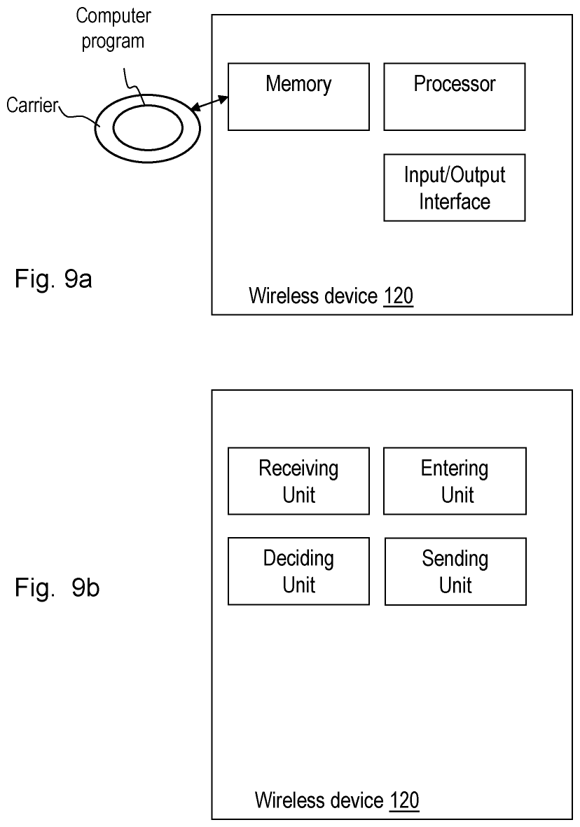

FIGS. 9a and 9b shows an example of arrangement in the wireless device 120.

The wireless device 120 may comprise an input and output interface configured to communicate with each other. The input and output interface may comprise a wireless receiver (not shown) and a wireless transmitter (not shown).

The wireless device 120 may comprise an entering unit, a sending unit, receiving unit, and a deciding unit to perform the method actions as described herein.

The embodiments herein may be implemented through a respective processor or one or more processors, such as the processor of a processing circuitry in the wireless device 120 depicted in FIG. 9a, together with computer program code for performing the functions and actions of the embodiments herein. The program code mentioned above may also be provided as a computer program product, for instance in the form of a data carrier carrying computer program code for performing the embodiments herein when being loaded into the wireless device 120. One such carrier may be in the form of a CD ROM disc. It is however feasible with other data carriers such as a memory stick. The computer program code may furthermore be provided as pure program code on a server and downloaded to the wireless device 120.

The wireless device 120 may further comprise respective a memory comprising one or more memory units. The memory comprises instructions executable by the processor in the wireless device 120.

The memory is arranged to be used to store instructions, data, configurations, and applications to perform the methods herein when being executed in the wireless device 120.

In some embodiments, a computer program comprises instructions, which when executed by the at least one processor, cause the at least one processor of the wireless device 120 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the wireless device 120, described below may refer to a combination of analog and digital circuits, and/or one or more processors configured with software and/or firmware, e.g. stored in the wireless device 120, that when executed by the respective one or more processors such as the processors described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

FIGS. 10a and 10b shows an example of arrangements in the Network node 110.

The Network node 110 may comprise an input and output interface configured to communicate with each other. The input and output interface may comprise a wireless receiver (not shown) and a wireless transmitter (not shown).

The Network node 110 may comprise a handling unit, a configuring unit, and a receiving unit configured to perform the method actions as described herein.

The embodiments herein may be implemented through a respective processor or one or more processors, such as the processor of a processing circuitry in the Network node 110 depicted in FIG. 17a, together with respective computer program code for performing the functions and actions of the embodiments herein. The program code mentioned above may also be provided as a computer program product, for instance in the form of a data carrier carrying computer program code for performing the embodiments herein when being loaded into the Network node 110. One such carrier may be in the form of a CD ROM disc. It is however feasible with other data carriers such as a memory stick. The computer program code may furthermore be provided as pure program code on a server and downloaded to the Network node 110.

The Network node 110 may further comprise respective a memory comprising one or more memory units. The memory comprises instructions executable by the processor in the Network node 110.

The memory is arranged to be used to store instructions, data, configurations, and applications to perform the methods herein when being executed in the Network node 110.

In some embodiments, a computer program comprises instructions, which when executed by the at least one processor, cause the at least one processor of the Network node 110 to perform the actions above.

In some embodiments, a respective carrier comprises the respective computer program, wherein the carrier is one of an electronic signal, an optical signal, an electromagnetic signal, a magnetic signal, an electric signal, a radio signal, a microwave signal, or a computer-readable storage medium.

Those skilled in the art will also appreciate that the functional modules in the Network node 110, described below may refer to a combination of analog and digital circuits, and/or one or more processors configured with software and/or firmware, e.g. stored in the Network node 110, that when executed by the respective one or more processors such as the processors described above cause the respective at least one processor to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

Below, some example embodiments 1-24 are shortly described. See e.g. FIGS. 2-3, 9a, 9b, 10a and 10b.

Embodiment 1. E.g. relating to Rule #0. A method performed by a wireless device 120, e.g. for handling configured resources, such as e.g. Configured Grant, CG, resources for a data transmission, such as e.g. a Small Data Transmission, SDT, to a network node 110 in a wireless communications network 100, the method comprising: any one or more out of:

when being in connected mobility state, receiving 201 from the network node 110, a configuration for resources, such as e.g. the Configured Grant, CG, resources, for the data transmission, e.g. a Small Data Transmission, SDT, at a first point in time, T1,

entering 202 into inactive mobility state,

when being in inactive mobility state, deciding, e.g. evaluating, 203 whether or not a Timing Advance, TA, for the resources configured for the data transmission at T1 is valid at a second point in time, T2,

sending 204 an indication to the network node 110, indicating whether or not the TA for the resources configured for the data transmission at T1 is valid at a second point in time, T2, as decided.

Embodiment 2. The method according to embodiment 1, wherein:

the indication to the network node 110, is sent when it has been decided that the TA for the resources configured for the data transmission at T1 is not valid at T2, and which indication indicates that the TA is not valid at T2.

Embodiment 3. E.g. relating to Rule #1, the method according to any of embodiments 1 to 2, wherein:

the deciding, e.g. evaluating, 203 of whether or not the TA for the resources configured for the data transmission at T1 is valid at T2, is based on one or more conditions, e.g. referred to as criteria.

Embodiment 4. E.g. relating to Rule 1-1, the method according to any of embodiments 1-3, wherein the configured resources, such as e.g. CG resources, comprises any one or more out of:

one or more configured PUSCH resources, such as e.g. CG, Physical Uplink Shared Channel, PUSCH, resources,

one or more beams associated with the configured resources, and

transmission periodicity using the configured configured resources, e.g. preconfigured resources, PUR.

Embodiment 5. E.g. relating to Rule 1-1, the method according to any of embodiments 2-3, wherein the one or more conditions comprises any one or more out:

whether or not the one or more configured resources comprising PUSCH resources, such as e.g. CG PUSCH resources, fulfills a first threshold, e.g. N1,

whether or not the one or more beams associated with the resources fulfills a second threshold, e.g. N2,

whether or not the transmission periodicity using the configured resources, e.g. preconfigured resources, PUR, fulfills a third threshold, K, e.g. uses more time resources than K wherein the time resources are any one of: milliseconds, slots, frames, and System Frame Number, SFN, cycles,

Embodiment 6. E.g. relating to Rule 1-2, the method according to any of embodiments 2-3, wherein the one or more conditions comprises any one or more out:

whether or not beam changes occurred for one or more beams associated with the configured resources, between time T1 and time T2, and whether or not a number of beams associated with the configured resources, have changed, e.g. increased or decreased, between time T1 and time T2.

Embodiment 7. E.g. relating to Rule 1-3, the method according to any of embodiments 1 to 5, wherein the one or more conditions are based on a timer, e.g. TA Timer, TAT, which timer expires at a third point in time, T3, and wherein the one or more conditions comprises any one or more out:

whether or not the difference between time T2 and time T3 fulfills, e.g. exceeds, a fifth threshold,

whether or not T3-δt2-T2±δt1 fulfills, e.g. exceeds, a sixth threshold; wherein the TA becomes invalid at T2 and TAT is configured to expire at T3, e.g. wherein δt1 correspond to time between T2 and closest PUR occasion in time and/or wherein δt2 correspond to time between T3 and closest PUR occasion in time, T_{d}=difference between T2 and T3, and T3=T3-δt2-T2±δt1 and

whether or not T3 fulfills, e.g. exceeds, a seventh threshold.

Embodiment 8. The method according to any of embodiments 1-7, wherein the sending 202 of the indication to the network node 110, comprises sending an explicit or implicit indication.

Embodiment 9. A computer program comprising instructions, which when executed by a processor, causes the processor to perform actions according to any of the embodiments 1-8.

Embodiment 10. A carrier comprising the computer program of embodiment 9, wherein the carrier is one of an electronic signal, an optical signal, an electromagnetic signal, a magnetic signal, an electric signal, a radio signal, a microwave signal, or a computer-readable storage medium.

Embodiment 11. A method performed by a network node 110, for handling, e.g. controlling, resources, such as e.g. Configured Grant, CG, resources for a data transmission, such as e.g. a Small Data Transmission, SDT, the method comprising: any one or more out of:

configuring 301 a wireless device 120 with resources, such as e.g. the Configured Grant, CG, resources for the data transmission, e.g. a Small Data Transmission, SDT, at a first point in time, T1, which data transmission is from the wireless device 120 to the network node 110 in a wireless communications network 100,

when the wireless device 120 is in an inactive mobility state, receiving 302 an indication from the wireless device 120, which indication indicates whether or not the TA for the resources configured for the data transmission at T1 is valid at a second point in time, T2, as decided by the wireless device 120, and handling, e.g. controlling 303, the resources, such as e.g. Configured Grant, CG, resources based on the received indication.

Embodiment 12. The method according to embodiment 11, wherein handling, e.g. controlling 303, the resources, comprises any one or more out of: releasing the configured resources for data transmission and/or configuring the released resources to one or more other wireless devices.

Embodiment 13. A computer program comprising instructions, which when executed by a processor, causes the processor to perform actions according to any of the embodiments 11-12.

Embodiment 14. A carrier comprising the computer program of embodiment 13, wherein the carrier is one of an electronic signal, an optical signal, an electromagnetic signal, a magnetic signal, an electric signal, a radio signal, a microwave signal, or a computer-readable storage medium.

Embodiment 15. E.g. relating to Rule #0. A wireless device 120, e.g. configured to handle configured resources, such as e.g. Configured Grant, CG, resources for a data transmission, such as e.g. a Small Data Transmission, SDT, to a network node 110 in a wireless communications network 100, the wireless device 120 further being configured to any one or more out of:

when being in connected mobility state, receive, e.g. by means of a receiving unit, from the network node 110, a configuration for resources, such as e.g. the Configured Grant, CG, resources, for the data transmission, e.g. a Small Data Transmission, SDT, at a first point in time, T1,

enter, e.g., by means of an entering unit, into inactive mobility state,

when being in inactive mobility state, decide, e.g. evaluating, e.g. by means of a deciding unit, whether or not a Timing Advance, TA, for the resources configured for the data transmission at T1 is valid at a second point in time, T2,

send, e.g. by means of a sending unit, an indication to the network node 110, indicating whether or not the TA for the resources configured for the data transmission at T1 is valid at a second point in time, T2, as decided.

Embodiment 16. The wireless device 120 according to embodiment 15, wherein:

the indication to the network node 110, is adapted to be sent, e.g. by means of the sending unit, when it has been decided that the TA for the resources configured for the data transmission at T1 is not valid at T2, and which indication is adapted to indicate that the TA is not valid at T2.

Embodiment 17. E.g. relating to Rule #1, the wireless device 120 according to any of embodiments 15 to 16, further being configured to:

decide, e.g. evaluating, e.g. by means of the deciding unit, of whether or not the TA for the resources configured for the data transmission at T1 is valid at T2, by basing it on one or more conditions, e.g. referred to as criteria.

Embodiment 18. E.g. relating to Rule 1-1, the wireless device 120 according to any of embodiments 15-17, wherein the configured resources, such as e.g. CG resources, are adapted to comprise any one or more out of:

one or more configured PUSCH resources, such as e.g. CG, Physical Uplink Shared Channel, PUSCH, resources,

one or more beams associated with the configured resources, and

transmission periodicity using the configured configured resources, e.g. preconfigured resources, PUR.

Embodiment 19. E.g. relating to Rule 1-1, the wireless device 120 according to any of embodiments 15-18, wherein the one or more conditions are adapted to comprise any one or more out:

whether or not the one or more configured resources comprising PUSCH resources, such as e.g. CG PUSCH resources, fulfills a first threshold, e.g. N1,

whether or not the one or more beams associated with the resources fulfills a second threshold, e.g. N2,

whether or not the transmission periodicity using the configured resources, e.g. preconfigured resources, PUR, fulfills a third threshold, K, e.g. uses more time resources than K wherein the time resources are any one of: milliseconds, slots, frames, and System Frame Number, SFN, cycles,

Embodiment 20. E.g. relating to Rule 1-2, the wireless device 120 according to any of embodiments 15-19, wherein the one or more conditions are adapted to comprise any one or more out:

whether or not beam changes occurred for one or more beams associated with the configured resources, between time T1 and time T2, and whether or not a number of beams associated with the configured resources, have changed, e.g. increased or decreased, between time T1 and time T2.

Embodiment 21. E.g. relating to Rule 1-3, the wireless device 120 according to any of embodiments 15 to 20, wherein the one or more conditions are adapted to be based on a timer, e.g. TA Timer, TAT, which timer is adapted to expire at a third point in time, T3, and wherein the one or more conditions are adapted to comprise any one or more out:

whether or not the difference between time T2 and time T3 fulfills, e.g. exceeds, a fifth threshold,

whether or not T3-δt2-T2±δt1 fulfills, e.g. exceeds, a sixth threshold; wherein the TA becomes invalid at T2 and TAT is configured to expire at T3, e.g. wherein δt1 correspond to time between T2 and closest PUR occasion in time and/or wherein δt2 correspond to time between T3 and closest PUR occasion in time, T_{d}=difference between T2 and T3, and T3=T3-δt2-T2±δt1, and

whether or not T3 fulfills, e.g. exceeds, a seventh threshold.

Embodiment 22. The wireless device 120 according to any of embodiments 15-21, further configured to send, e.g. by means of the sending unit, the indication to the network node 110, by sending an explicit or implicit indication.

Embodiment 23. A network node 110, configured to handle, e.g. control, resources, such as e.g. Configured Grant, CG, resources for a data transmission, such as e.g. a Small Data Transmission, SDT, the network node 110 further being configured to any one or more out of:

configure, e.g. by means of a configuring unit, a wireless device 120 with resources, such as e.g. the Configured Grant, CG, resources, for the data transmission, e.g. a Small Data Transmission, SDT, at a first point in time, T1, which data transmission is arranged to be from the wireless device 120 to the network node 110 in a wireless communications network 100,

when the wireless device 120 is in an inactive mobility state, receive, e.g. by means of a receiving unit, an indication from the wireless device 120, which indication is adapted to indicate whether or not the TA for the resources configured for the data transmission at T1 is valid at a second point in time, T2, as arranged to be decided by the wireless device 120, and

handle, e.g. control, e.g. by means of a handling unit, the resources, such as e.g. Configured Grant, CG, resources based on the received indication.

Embodiment 24. The network node 110 according to embodiment 23 further configured to handle, e.g. control, e.g. by means of the handling unit, the resources, by any one or more out of: releasing the configured resources for data transmission and/or configuring the released resources to one or more other wireless devices.

Further Extensions and Variations

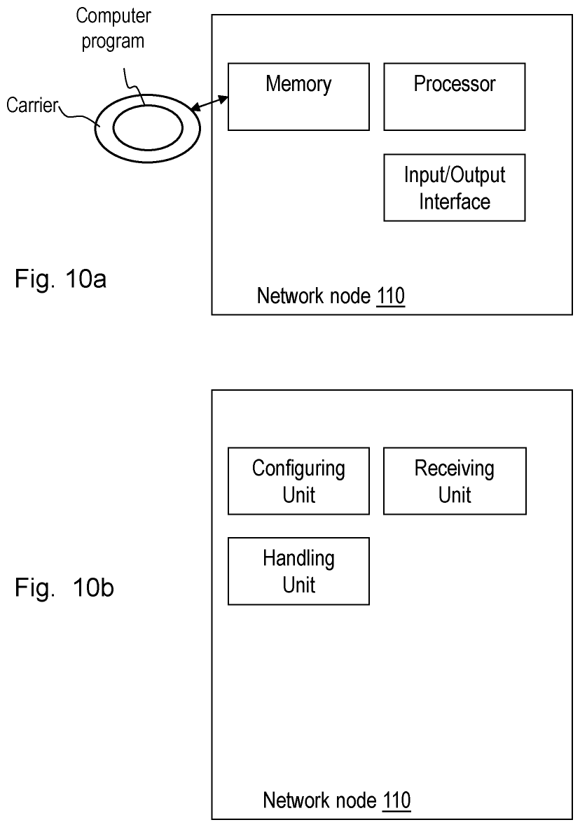

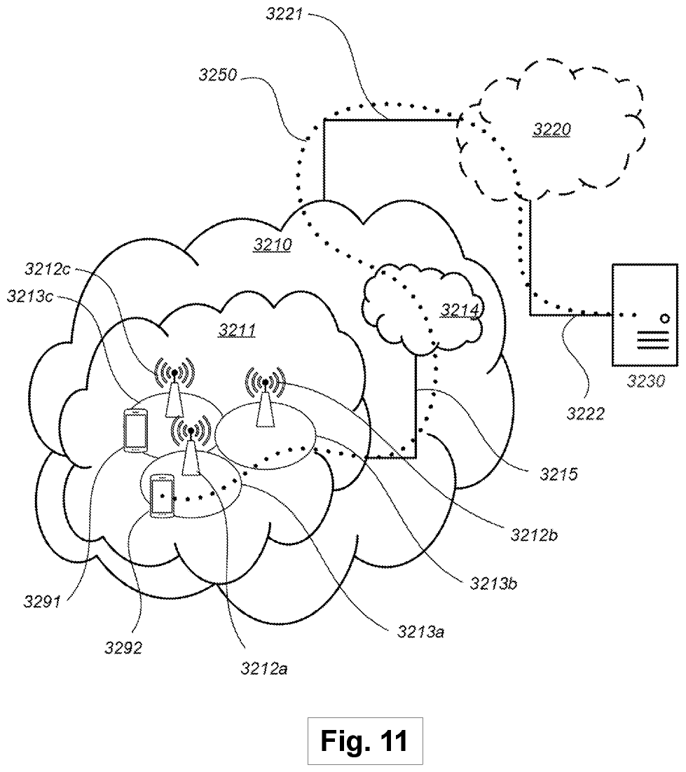

With reference to FIG. 11, in accordance with an embodiment, a communication system includes a telecommunication network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 110, 130, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the wireless device 120 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 11 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

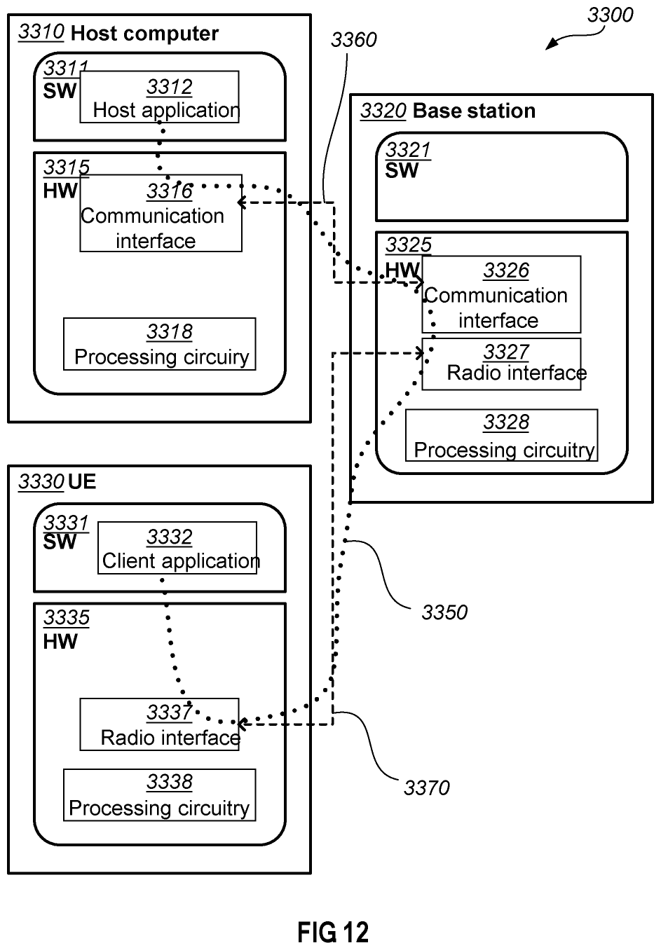

Example implementations, in accordance with an embodiment, of the UE, base station and host computer discussed in the preceding paragraphs will now be described with reference to FIG. 12. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 12) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides. It is noted that the host computer 3310, base station 3320 and UE 3330 illustrated in FIG. 12 may be identical to the host computer 3230, one of the base stations 3212a, 3212b, 3212c and one of the UEs 3291, 3292 of FIG. 11, respectively. This is to say, the inner workings of these entities may be as shown in FIG. 12 and independently, the surrounding network topology may be that of FIG. 11.

In FIG. 12, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure.

One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

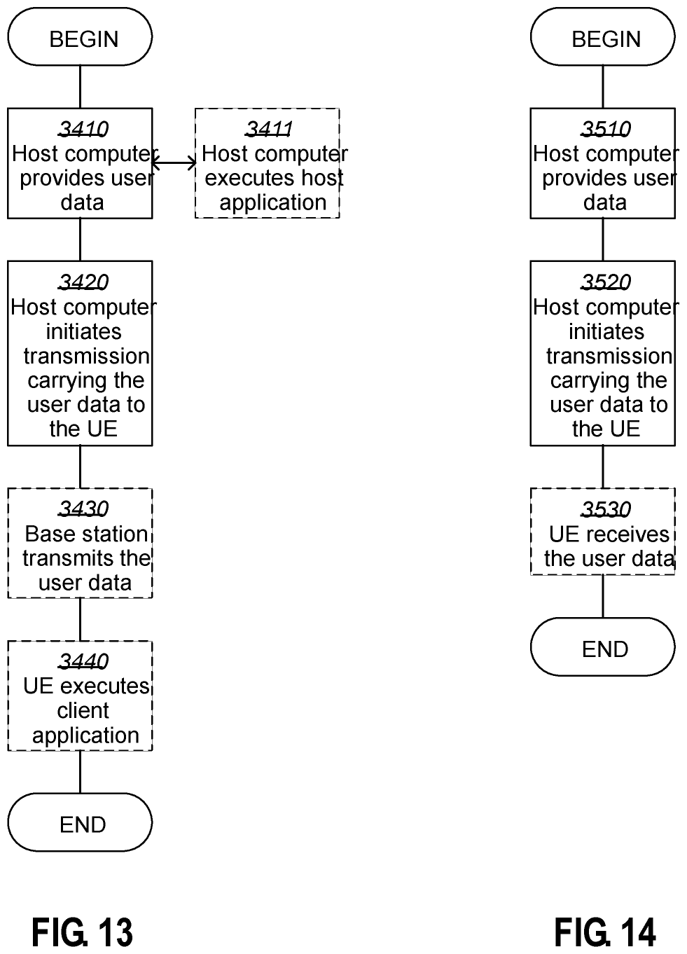

FIG. 13 is a flowchart illustrating a method implemented in a communication system, in accordance with one embodiment. The communication system includes a host computer, a base station such as the network node 110, and a UE such as the UE 120, which may be those described with reference to FIG. 10 and FIG. 12. For simplicity of the present disclosure, only drawing references to FIG. 13 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 14 is a flowchart illustrating a method implemented in a communication system, in accordance with one embodiment. The communication system includes a host computer, a base station such as a AP STA, and a UE such as a Non-AP STA which may be those described with reference to FIG. 11 and FIG. 12. For simplicity of the present disclosure, only drawing references to FIG. 14 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

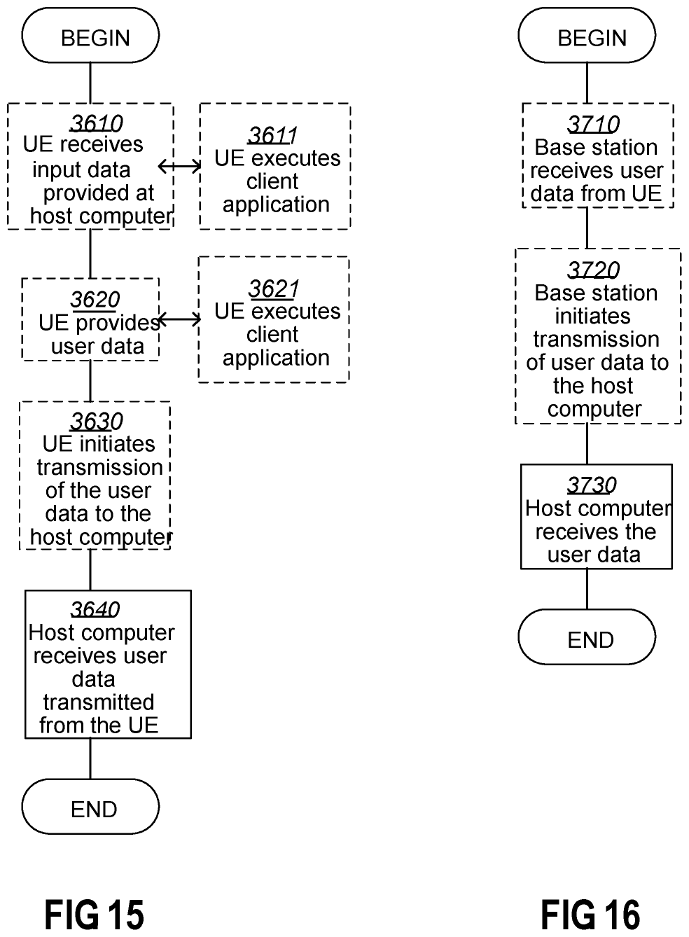

FIG. 15 is a flowchart illustrating a method implemented in a communication system, in accordance with one embodiment. The communication system includes a host computer, a base station such as a AP STA, and a UE such as a Non-AP STA which may be those described with reference to FIG. 11 and FIG. 12. For simplicity of the present disclosure, only drawing references to FIG. 15 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station such as a AP STA, and a UE such as a Non-AP STA which may be those described with reference to FIG. 11 and FIG. 12. For simplicity of the present disclosure, only drawing references to FIG. 16 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

### ABBREVIATIONS

The following abbreviations may be used in any of above text.

| Abbreviation | Explanation |
|---|---|
| CG | Configured Grant |
| CP | Cyclic Prefix |
| ECP | Extended CP |
| NR | New radio |
| PUSCH | Physical Uplink Shared Channel |
| RACH | Random Access Channel |
| SCS | Subcarrier Spacing |
| SDT | Small Data Transmission |
| SSB | SS/PBCH block comprising of synchronization signals and |
| | physical broadcast channel |

1-26. (canceled)

27. A method performed by a wireless device for handling configured resources for a data transmission to a network node in a wireless communications network, the method comprising:
when being in connected mobility state, receiving from the network node at a first point in time T1 a configuration for resources for the data transmission,
entering into inactive mobility state,
when being in inactive mobility state, deciding whether or not a Timing Advance (TA) for the resources configured at T1 for the data transmission is valid at a second point in time T2, and sending an indication to the network node, indicating whether or not the TA for the resources configured for the data transmission at T1 is valid at a second point in time T2 as decided.

28. The method according to claim 27, wherein:
the indication to the network node is sent when it has been decided that the TA for the resources configured at T1 for the data transmission is not valid at T2, wherein the indication indicates that the TA is not valid at T2.

29. The method according to any of claim 27, wherein:
the deciding of whether or not the TA for the resources configured at T1 for the data transmission is valid at T2 is based on one or more conditions.

30. The method according to claim 27, wherein the configured resources comprise one or more of the following:
one or more configured Physical Uplink Shared Channel (PUSCH) resources,
one or more beams associated with the configured resources, and
transmission periodicity using the configured resources.

31. The method according to claim 30, wherein the one or more conditions comprise one or more of the following:
whether or not the one or more configured resources comprising PUSCH resources fulfill a first threshold,
whether or not the one or more beams associated with the configured resources fulfill a second threshold,
whether or not the transmission periodicity using the configured resources fulfills a third threshold K,
whether or not a magnitude of change in serving cell Reference Signal Receive Power (RSRP) fulfils a fourth threshold,
whether or not beam changes for the one or more beams associated with the configured resources occurred between time T1 and time T2, and
whether or not a number of beams associated with the configured resources have changed between time T1 and time T2.

32. The method according to claim 29, wherein the one or more conditions are based on a timer, the timer expiring at a third point in time T3, and wherein the one or more conditions comprise one or more of the following:
whether or not a time difference between T2 and T3 fulfills a fifth threshold,
whether or not ((T3-δt2)−(T2-δ1) fulfills a sixth threshold, wherein the TA becomes invalid at T2 and Time alignment Timer (TAT) is configured to expire at T3, wherein δt1 corresponds to time between T2 and closest Preconfigured Uplink Resources (PUR) occasion in time, and wherein δ2 corresponds to time between T3 and closest PUR occasion in time, and
whether or not T3 fulfills a seventh threshold.

33. The method according to claim 27, wherein the sending of the indication to the network node comprises sending an explicit or implicit indication.

34. A method performed by a network node for handling resources for a data transmission, the method comprising:
configuring at a first point in time T1 a wireless device with resources for the data transmission, wherein the data transmission is from the wireless device to the network node in a wireless communications network,
when the wireless device is in an inactive mobility state, receiving an indication from the wireless device, wherein the indication indicates whether or not the timing advance (TA) for the resources configured at T1 for the data transmission is valid at a second point in time T2 as decided by the wireless device.

35. The method according to claim 34, further comprising:
handling the resources based on the received indication.

36. The method according to claim 35, wherein the handling of the resources comprises one or more of the following: releasing the configured resources for data transmission and/or configuring the released resources to one or more other wireless devices.

37. A wireless device configured to handle configured resources for a data transmission to a network node in a wireless communications network, the wireless device comprising:
a processor configured to:
when being in connected mobility state, receive from the network node at a first point in time T1 a configuration for resources for the data transmission,
enter into inactive mobility state,
when being in inactive mobility state, decide whether or not a Timing Advance (TA) for the resources configured at T1 for the data transmission is valid at a second point in time T2, and
send an indication to the network node, indicating whether or not the TA for the resources configured at T1 for the data transmission is valid at a second point in time T2 as decided.

38. The wireless device according to claim 37, wherein the indication to the network node is configured to be sent when the processor has decided that the TA for the resources configured at T1 for the data transmission is not valid at T2, and wherein the indication is configured to indicate that the TA is not valid at T2.

39. The wireless device according to claim 37, wherein the processor is further configured to:
decide whether or not the TA for the resources configured at T1 for the data transmission is valid at T2, based on one or more conditions.

40. The wireless device according to claim 37, wherein the configured resources are configured to comprise one or more of the following:
one or more configured Physical Uplink Shared Channel (PUSCH) resources,
one or more beams associated with the configured resources, and
transmission periodicity using the configured resources.

41. The wireless device according to claim 40, wherein the one or more conditions are configured to comprise one or more of the following:
whether or not the one or more configured resources comprising PUSCH resources fulfill a first threshold,
whether or not the one or more beams associated with the configured resources fulfill a second threshold,
whether or not the transmission periodicity using the configured resources fulfills a third threshold K,
whether or not a magnitude of change in serving cell Reference Signal Receive Power (RSRP) fulfils a fourth threshold,
whether or not beam changes for one or more beams associated with the configured resources occurred between time T1 and time T2, and
whether or not a number of beams associated with the configured resources have changed between time T1 and time T2.

42. The wireless device according to claim 39, wherein the one or more conditions are based on a timer, wherein the timer is configured to expire at a third point in time T3, and
wherein the one or more conditions are configured to comprise one or more of the following:
whether or not a time difference between T2 and T3 fulfills a fifth threshold, whether or not ((T3-δt2)−(T2-δ1)) fulfills a sixth threshold, wherein the TA becomes invalid at T2 and Time Alignment Timer (TAT) is configured to expire at T3, wherein δt1 corresponds to time between T2 and closest Preconfigured Uplink Resources (PUR) occasion in time, and wherein δ2 corresponds to time between T3 and closest PUR occasion in time, and
whether or not T3 fulfills a seventh threshold.

43. The wireless device according to claim 37, wherein the processor is further configured to send the indication to the network node by sending an explicit or implicit indication.

44. A network node configured to handle resources for a data transmission, the network node comprising:
a processor configured to:
configure at a first point in time T1 a wireless device with resources for the data transmission, wherein the data transmission is arranged to be from the wireless device to the network node in a wireless communications network,
when the wireless device is in an inactive mobility state, receive an indication from the wireless device, wherein the indication is configured to indicate whether or not the TA for the resources configured at T1 for the data transmission is valid at a second point in time T2 as arranged to be decided by the wireless device.

45. The network node according to claim 44, wherein the processor is configured to:
handle the resources based on the received indication.

46. The network node according to claim 45, wherein the processor is further configured to handle the resources by one or more of the following: releasing the configured resources for the data transmission and/or configuring the released resources to one or more other wireless devices.
